(19) United States
(12) Patent Application Publication
(10) Pub. No.: US 2002/0019844 A1
(43) Pub. Date: Feb. 14, 2002

(54) Method and system for network-distributed computing

(76) Inventors: Scott J. Kurowski, San Diego, CA (US); Iqbal Mustafa Khan, Union City, CA (US)

Correspondence Address: FITCH EVEN TABIN AND FLANNERY, 120 SOUTH LA SALLE STREET, SUITE 1600, CHICAGO, IL, 606033406

(21) Appl. No.: 09/759,635

(22) Filed: Jan. 12, 2001

Related U.S. Application Data
(60) Provisional application No. 60/215,746, filed on Jul. 6, 2000.

(51) Int. Cl. G06F 15/16

(52) U.S. Cl. 709/201

(57) ABSTRACT

A distributed computing system achieves a highly distributed environment where very large computation intensive tasks are broken down into thousands of sub-tasks and then distributed to thousands of clients running on a variety of computers across the Internet. The idle CPU time of each of these thousands of client computers is used to perform these computations by running custom application modules in a low priority. A task server keeps track of information associated with each of the clients and uses the information to assign one or more tasks associated with a computing problem to each client computer. A file server provides the application modules to the client computers for executing their assigned tasks. An application server provides input data for the application modules and receives output data from the application modules. Status and performance information for machines, accounts and teams is collected by the task server and displayed on a background page of each client. Incentives for commitments of computing time are provided to users of potential client computers.

### CROSS-REFERENCE TO RELATED APPLICATION

This application claims priority under 35 U.S.C. 119(e) to U.S. Provisional Patent Application No. 60/215,746, filed Jul. 6, 2000, of Scott J. Kurowski and Iqbal Mustafa Khan, for METHOD AND SYSTEM FOR NETWORK-DISTRIBUTED COMPUTING, which U.S. Provisional Patent Application is hereby fully incorporated herein by reference.

### BACKGROUND OF THE INVENTION

1. Field of the Invention

The present invention relates generally to distributed computing, and more specifically to large-scale network-distributed computing.

2. Discussion of the Related Art

For many years, users with large-scale computational needs have purchased expensive hardware systems to deliver computing services. This often requires capital investment, system administration, and hardware maintenance. Increasingly, companies are realizing that their needs can be efficiently met by outsourcing their computational services.

Distributed computing is a form of information processing in which work is performed by separate computers linked through a communications network. Separate computers perform different tasks in such a way that their combined work can contribute to a larger goal. This type of processing requires a highly-structured environment that allows hardware and software to communicate, share resources, and exchange information freely.

There is a need for a system and/or method for providing computational power to deliver computing services at a lower cost. SUMMARY OF THE INVENTION

The present invention advantageously addresses the needs above as well as other needs by providing a system for use in distributed computing. The system includes a task server, a file server, and an application server. The task server is configured to keep track of information associated with each of a multiplicity of client computers and to use the information to assign one or more tasks associated with a computing problem to each client computer. The file server is configured to provide application modules to the client computers for executing their assigned tasks. The application server is configured to provide input data for the application modules to the client computers and to receive output data of the application modules from the client computers.

In another embodiment, the invention can be characterized as a method for use in a distributed computing system. The method includes the steps of: providing a client program for installation on a client computer; receiving, through a computer network, information associated with the client computer that is collected by the client program installed on the client computer; using the information to assign one or more tasks associated with a computing problem to the client computer; and providing one or more application modules to the client computer for executing its assigned tasks, wherein the application modules are executable by the client program and are provided through the computer network.

In a further embodiment, the invention can be characterized as a method for use in a distributed computing system. The method includes the steps of: sending a request for a new task through a computer network to a first server, the request including user identification information; receiving module information from the first server through the computer network in response to the request, the module information including locator information for a second server in the computer network where a module can be obtained; redirecting to the second server using the locator information; and receiving the module from the second server through the computer network.

In an additional embodiment, the invention can be characterized as a method for use in a distributed computing system. The method includes the steps of: receiving a request for a new task from a client through a computer network, the request including user identification information; assembling module information in response to the request, the module information including locator information indicating a location in the computer network where a module can be obtained; sending the module information to the client through the computer network; and sending the module to the client through the computer network from the location in the computer network.

In an additional embodiment, the invention can be characterized as a method of providing status information associated with a distributed computing project. The method includes the steps of: generating a first item of performance information for a first client computer participating in the distributed computing project; sending the first item of performance information from the first client computer through a computer network to a first server; receiving a second item of performance information at the first client computer from the first server through the computer network, wherein the second item of performance information is based on the first item of performance information and one or more additional items of performance information from one or more additional client computers participating in the distributed computing project; and displaying the second item of performance information on the first client computer.

In an additional embodiment, the invention can be characterized as a method of providing status information associated with a distributed computing project. The method includes the steps of: receiving, through a computer network, performance information from a plurality of client computers participating in the distributed computing project; totaling the performance information for a subset of the plurality of client computers that are members of a first team in order to generate team performance information; and sending display data through the computer network to each of the client computers that are members of the first team, wherein the display data is configured to display status information that includes the team performance information.

In an additional embodiment, the invention can be characterized as a method for use in a distributed computing system. The method includes the steps of: offering an incentive for a commitment of computing time from a user's computer in the distributed computing system; providing a client program to the user for installation on the user's computer; registering the user's computer as a client in the distributed computing system; and providing the incentive to the user.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a block diagram illustrating a basic service model for one exemplary version of a distributed computing system made in accordance with the present invention;

FIG. 2 is a block diagram illustrating an exemplary configuration for a distributed computing system made in accordance with the present invention;

FIG. 3 is a system organization diagram illustrating the different parts that make up a distributed computing system made in accordance with one exemplary embodiment of the present invention;

FIG. 4 is a system diagram illustrating an exemplary architecture for the major subsystems of a client made in accordance with one embodiment of the present invention;

FIG. 5 is a system diagram illustrating an exemplary architecture for the different subsystems of a Task Server in accordance with one embodiment of the present invention;

FIGS. 6A and 6B are flowcharts illustrating exemplary processes for providing incentives in accordance with one embodiment of the present invention;

FIG. 7 is a flowchart illustrating an exemplary process for operating a client in a distributed computing system in accordance with one embodiment of the present invention;

FIG. 8 is a screen shot illustrating an exemplary network settings dialog box that may be used with the client;

FIG. 9 is a screen shot illustrating an exemplary account information setup dialog box that may be used with the client;

FIG. 10 is a screen shot illustrating an exemplary program options dialog box that may be used with the client;

FIGS. 11, 12, 13, 14 and 15 are screen shots illustrating exemplary dialog boxes that may be displayed during a configuration process used to configure the client software;

FIG. 16 is a screen shot illustrating an exemplary interface having an HTML page that may be used with the client;

FIGS. 17 and 18 are screen shots illustrating exemplary HTML background pages that may be used with the client;

FIG. 19 is a flowchart illustrating an exemplary method for providing status information in accordance with one embodiment of the present invention;

FIGS. 20, 21, 22, and 23 are screen shots illustrating exemplary displays that may be used for implementing the “integrated” web site feature of the present invention;

FIG. 24 is a system diagram illustrating an exemplary architecture for a task server engine made in accordance with one embodiment of the present invention;

FIG. 25 is a class diagram illustrating an exemplary command and recordset subsystem that may be used with a task server engine made in accordance with one embodiment of the present invention; and

FIGS. 26A and 26B are an ER diagram illustrating an exemplary task server core database logical and physical design in accordance with one embodiment of the present invention.

Corresponding reference characters indicate corresponding components throughout the several views of the drawings.

### DETAILED DESCRIPTION OF THE PREFERRED EMBODIMENTS

The following description of the presently contemplated best mode of practicing the invention is not to be taken in a limiting sense, but is made merely for the purpose of describing the general principles of the invention. The scope of the invention should be determined with reference to the claims.

The methods and systems described herein provide for a new market of innovative, affordable network computing services. These services can scale with the Internet and support high volume computing at dramatically lower prices. They will not only compete with low-end supercomputing vendors, but also catalyze an explosion of new applications enabled by the 10 to 100 times lower cost of computation. This radically new model of computational services will reshape a significant fraction of the information technology industry.

The methods and systems described herein provide for a very large Internet-scale computing service that is capable of dynamically delivering processing power—more than 1 trillion computations per second—to significantly speed the progress of medical, scientific and financial-market research, entertainment projects and the development of safer products. The distributed computing system allows PC owners to make a genuine difference, by for example, providing a free method to connect their computers' otherwise wasted processor time to important non-profit research that improves the quality of our lives and our world.

The distributed computing system described herein exploits cheap, powerful desktop computing systems and emerging broadband networks to create a pool of computational power to deliver computing services at dramatically lower cost (10× to 100×). The aggregate capacity of this system is capable of being far greater than the total computing power of the 500 largest computers in the world. Thus, this system may be used in commercial and industrial distributed computing.

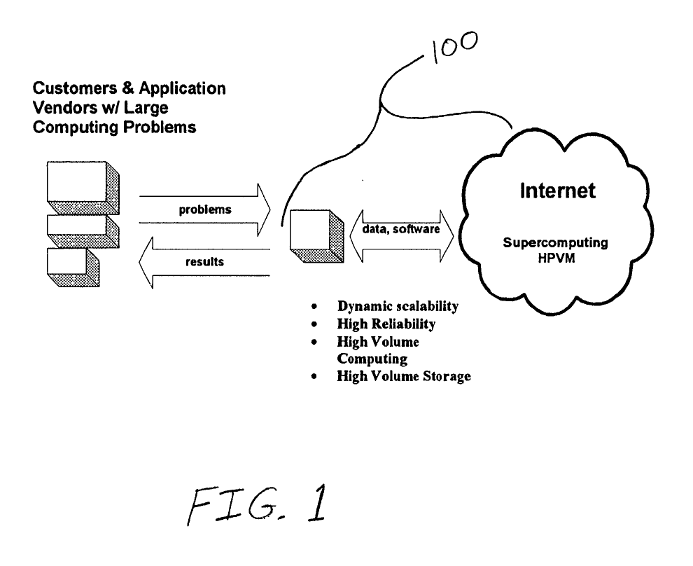

FIG. 1 illustrates a basic service model for one exemplary version of a distributed computing system 100 and methods described herein.

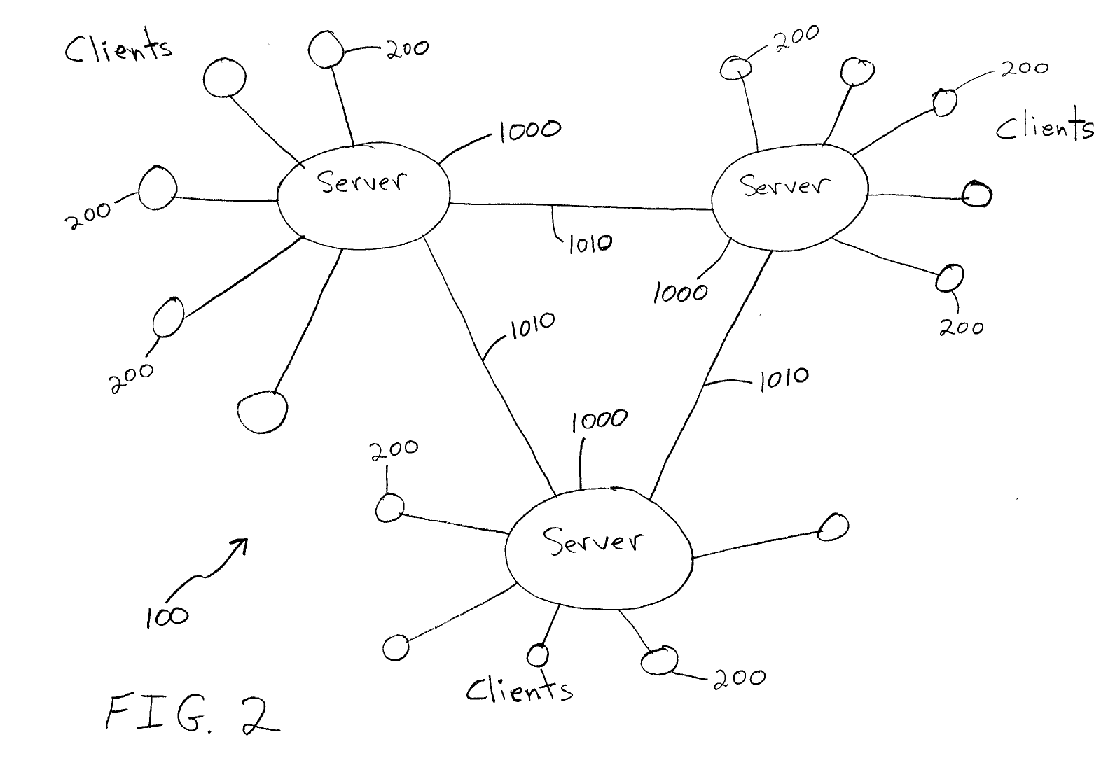

FIG. 2 further illustrates an exemplary configuration for a distributed computing system 100 made in accordance with the present invention. Thousands or millions of Internet-connected computers in homes and business are used to provide massive computing power. Client software implementing methods described herein is installed on these computers, and these computers correspond to the “clients” 200 in the figure. The client software recycles the client PC's spare processing time to quietly work on important computing problems. This revolutionary client software runs in the background. Its amazing ability to stay out of the way of other software applications means the client computer 200 stays agile and responsive, even when the client software is running.

The client PC 200 periodically and automatically synchronizes its work with the system network using an ordinary Internet connection. The computer does not need to remain online, however, the system is best experienced with an always-on connection. The distributed computing system network is represented by the several “servers” 1000 in FIG. 2. These servers 1000 preferably comprise multiple systems or multiple units co-located around the Internet that logically operate as a single server from the point of view of the network. In other words, the servers 1000 are preferably distributed across the Internet. This means that there will generally not be just one single centralized server. Individual clients 200 will communicate with the server 1000 that is closest or most convenient. Each of these “servers” 1000 is logically a part of a broader distributed infrastructure. Each “server” 1000 is part of a replicated infrastructure that collectively operates as one control node or a single server. This architecture results in the network being a scalable Internet infrastructure. Thus, the system 100 described herein can in some embodiments be described as a network-distributed computing system.

Each of the several “servers” 1000 is preferably networked at a second layer 1010 among themselves at high speed in order to logically make software applications running in geographically separate locations logically part of the same calculation. The high-speed second layer network 1010 logically binds each of the “servers” 1000 together. This results in a network that in effect does not have a center, which further results in the network being fault tolerant. Thus, the server of the system described herein preferably comprises a distributed infrastructure of several or many different “servers” 1000.

With this system, one client 200 can work on one part of a calculation while a different client 200 works on another part of the same calculation. The distributed network of “servers” make the calculation all come together transparently.

Groups of client computers 200 can form a “team” to work on certain tasks. As will be discussed below, each client computer preferably has access to information about its “team”. The statistics, performance and information about team members is preferably tracked by the distributed network infrastructure. Thus, a client is part of a computation and part of a team and there is a reporting channel up into the server network and the information is reported back to the client so that there is real time feedback as to the status of the computation and the client's particular contribution. This feedback information is preferably at multiple levels meaning that a user can receive performance information about the user's machine, all the machines on the user's account, all the accounts on the user's team, and the entire application overall. This results in a community focus for distributed computing, i.e., a user can view reports for everyone on his or her team.

By recruiting computing power from millions of Internet-connected computers in homes and business, the systems described herein provide for a computing network with unprecedented computing, memory, and storage capacity, coupled by the rapid growth in broadband wide-area network and to-the-home deployment.

The potential of this system (1500 teraflops=million million operations per second) can exceed the total capacity of the world's 500 largest computers. The low-cost nature of these resources enable the underselling of competitors by 10× to 100× in price while providing better reliability and dynamic scalability. Remarkably, growth can continue at a rate faster than Moore's Law, as the number of nodes in the network grows as well as the speed of each individual computer. Potential strategic partners include computer vendors, ISP channel partners, independent software vendors, and service resellers.

The methods and systems described herein provide reliable, scalable, high volume computing capability to customers at a dramatically lower cost (10-100× cheaper). This capability will enable companies to outsource computationally intensive jobs, dynamically scale their computing to meet peak demand, and consume computing without capital expense or information technology infrastructure. These capabilities will capture both existing and new uses of existing software packages (the initial market) and catalyze the development of significant new applications and markets (the mature market). The ability of the systems described herein to provide massive computing with dynamic scalability (e.g. one million CPU's on demand), high reliability, and significantly lower cost (1% to 10%) below the competition will revolutionize computing. This system is capable of becoming the dominant provider of computing resources, and thereby the dominant back-end computational engine for application service providers (ASP's). Dataquest projects the ASP market to grow to $22 Billion in 2003. The breakthrough capabilities of the systems described herein will catalyze development of a wealth of new applications, further increasing demand for the services.

The technology described herein is capable of supporting the use of single processor applications, management of network performance, reliable execution, parallel applications, and use intelligent resource matching to achieve efficient use of the network. To an application user, the service described herein can have the appearance of an application service (ASP), with the network transparently providing the features of scalability, high performance, reliability and of course resource accounting and billing. The network can also support customer priority and differential tracking and scheduling for premium services. Thus, the major benefits of the services described herein include vastly more computing resources than ever before available, at much more affordable rates.

By way of example, an application package may be adapted to the systems and environment described herein either manually or automatically (using application liftoff and binary rewriting tools). These technologies enable preservation of the application execution environment and safe execution on network machines. The application runs or elements are scheduled automatically on the network, using resources appropriate to the application characteristics and pricing used. Results are collected, verified, and returned to the application user. The system's software environment ensures reliable execution, efficient scheduling, verifiable results, and precise resource tracking.

Networks using the systems described herein can grow by capturing a significant fraction of machines on the entire Internet, and preferably those machines with broadband connectivity. Note that cable modems (DOCSIS) and ADSL provide bandwidths of a few megabits. Rollouts of VDSL and other high-speed technologies are projected to provide >50 Mbps connectivity beginning in early 2001. Projected DOCSIS and ADSL growth numbers are based on “The DOCSIS Infrastructure Deployment Forecast”, published by Kinetic Strategies and “ADSL: Prospects and Possibilities”, published by the Center for Telecommunications Management at the U. of Southern California.

With respect to the resource market, on Oct. 4, 1999, Odyssey Research reported in the U.S. alone, private home PC owners operate some 29.7 million Internet connected machines running 35 hours/week. This represents a sustained 2.2 petaflops (a thousand million million operations per second) of computing power—many times more than the U.S. Government's multi-billion dollar ASCI initiative. FIND/SVP (June 1998) forecast 28 million Internet user households in the U.S. alone, very close to the Odyssey Research report finding. According to IDC (1998) this will continue to increase to about 102 million home users by 2002.

Worldwide, the total number of computers on the Internet more than doubled in 1998, to over 50 million.

GartnerGroup's Dataquest predicts growth to 269 million by 2002 (Newsweek, October 1997). Were this growth to continue exponentially, one would expect 400 million Internet connected computers in 2002, and over a billion in 2004. However, due to resource constraints this growth is likely to slow.

The power of the distributed computing systems described herein, such as for example the distributed computing system 100, grows at the product of Internet growth and the processor speed improvement governed by Moore's Law, producing very rapid geometric growth. Greater deployment of broadband and increases in network speed increase the flexibility with which resources can be used.

The system 100 generally includes two types of systems—those with broadband connectivity (cable modem, ADSL, or better connection) and those with only modem connectivity. High bandwidth connectivity is important to the versatility of resources for applications and therefore the customer revenue that can be captured. Customers wishing to tap their Intranet computing resources for a company-internal computing objective can delegate operational management of their Intranet machines to the system 100.

A population of modem-connected machines may be deployed as an entry-level supplier base. These typically include computers with dial-up or ISDN connections. As these computer owners upgrade to DSL or cable modem, they can join the distributed computing network. By keeping these dial-up or ISDN connections suppliers in the network, administrators of the system described herein are well positioned to capture their computing resources when they upgrade to higher speed connections.

As described herein, security and safety concerns are addressed so that small- to medium-sized businesses and people in homes can feel safe in running the client software associated with the system 100. Compensation can be provided for their otherwise idle background computer time, and the software can be made hands-free and automatic. The client software is designed to minimize real—or perceived—negative impacts to normal computer and Internet use.

Using the systems described herein, computing services may include fixed applications designed with ISV's offered as an application services (ASP's), custom applications developed in partnership with customers, enterprise intranet cluster computing resource management services, and raw computing services.

A software infrastructure which provides a virtual execution environment may be used to enable many applications to be moved to the system 100 network without change. This environment can allow applications run on the contributed machines, but be scheduled, managed and controlled by the distributed network.

By way of example, this affordable supercomputing time provided by the system 100 may be sold using a structured multi-tier pricing model. Premium rates may be charged for priority use, high levels or reliability, or other differentiated service attributes. Other aspects of fee structures may depend on computational, memory, disk storage, and network usage. Measures of use may be in units similar to kilowatt-hours, Gigaflop-hours or teraflop-days. As a marketing technique, low-end computing resources which are unable to be sold at full price may be donated (or sell at cost). The cycles may be used by various mathematical and non-profit users, yielding significant good will and public-relations exposure.

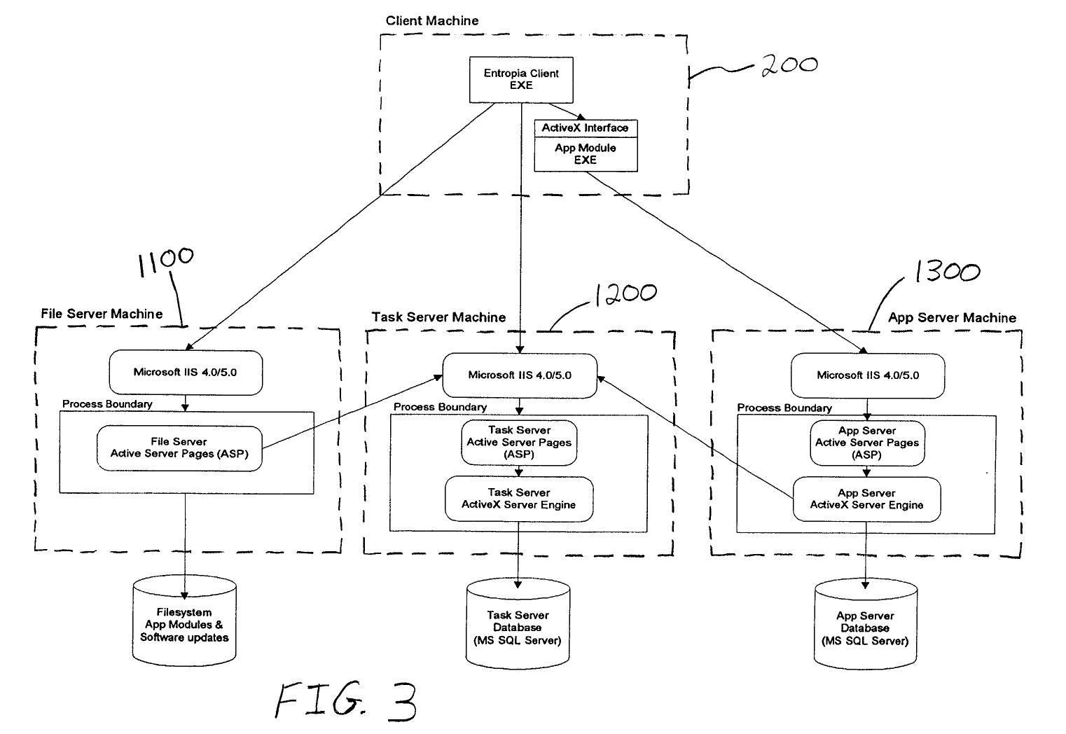

FIG. 3 is a system organization diagram that illustrates the different parts that make up a system made in accordance with one exemplary embodiment of the present invention. As illustrated, client machines 200 preferably interact with file server machines 1100, task server machines 1200, and application server machines 1300. The file server machines 1100, task server machines 1200, and application server machines 1300 may be physically located at different locations and distributed across the Internet as described above. By way of example, a client 200 may receive a task to work on from a task server 1200, and the client 200 may need to get application software to work on that task from an application server 1300.

The task servers are preferably networked among themselves, and a client can preferably connect to any task server in the grid. As will be discussed below, clients receive and execute application modules for executing their assigned tasks. Application modules are also referred to herein as computation modules, computational modules, task modules and/or simply modules. Application modules can preferably connect to any application server in the grid. The file servers may comprise distributed file servers.

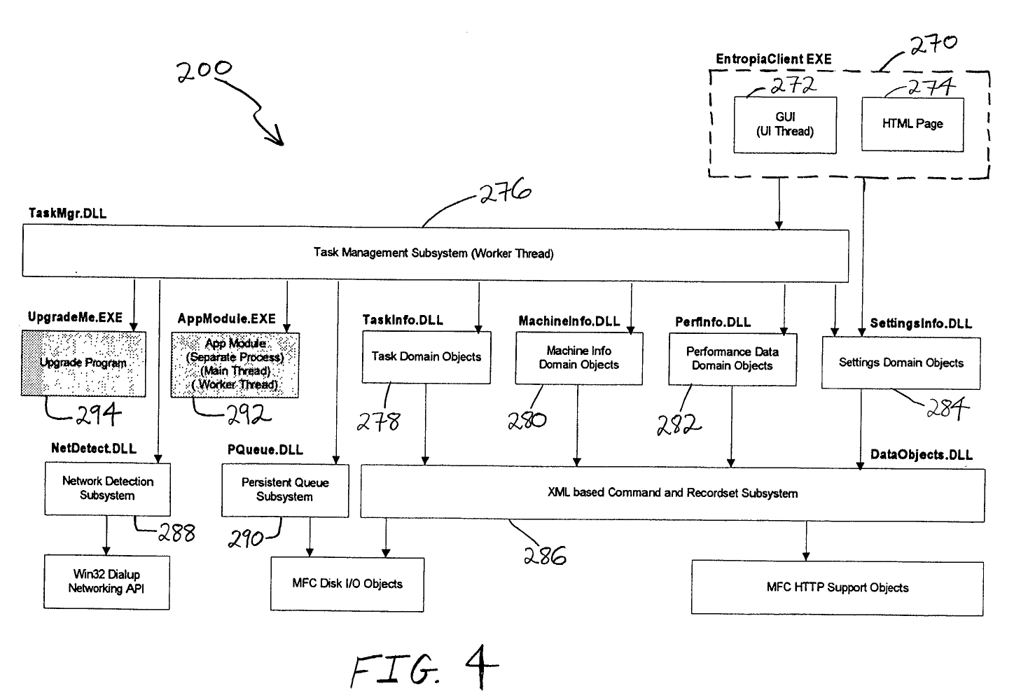

FIG. 4 illustrates an exemplary architecture for the major subsystems of a client 200 and its interaction and dependencies on each other in accordance with one exemplary embodiment of the present invention. The client 200 may comprise the desktop client software that functions as a distributed remote agent.

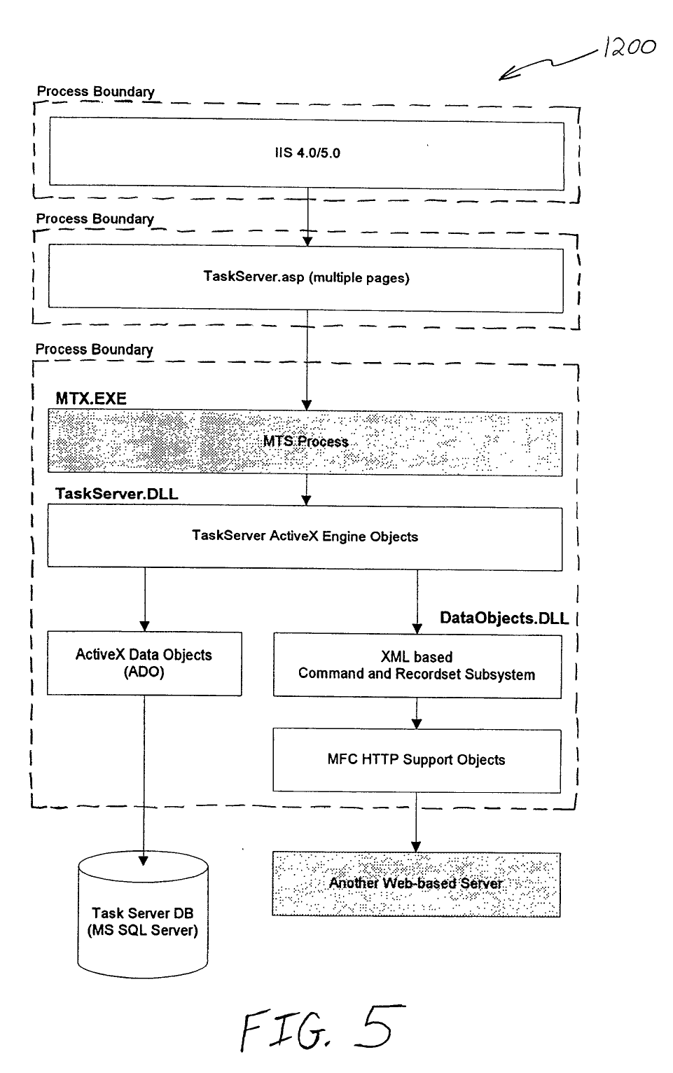

FIG. 5 illustrates an exemplary architecture for the different subsystems of a Task Server 1200 in accordance with one embodiment of the present invention. This diagram is similar to what an exemplary version of the Application Server 1300 architecture looks like. In other words, the Application Server 1300 can use the same type of system components as the Task Server 1200, but this is not required.

In one embodiment of the present invention the entire client/task server/application server/file server system can be utilized behind a corporate firewall on a company's internal network. A system similar to that shown in FIG. 3 can simply be “dropped in” behind the corporate firewall. Such a system may be leased to customers.

As will be discussed below, the Client 200 preferably provides an HTML page that is displayed on the client computer display. The HTML page is in the background of a window for the client area. The HTML background screen can preferably be opened by clicking on the Windows™ desktop icon next to the clock. The background screen is preferably a very dynamic web page. It could include information about the project and its sponsors. The administrators of the system described herein would have the ability to change the background screen. The HTML page is preferably linked to distributed applications that are being actively computed at that time. This way, when the system switches computational tasks, the HTML page changes. The HTML page preferably also includes status information for accounting that is linked back to the system web site. The status information may include, for example, account information and statistics. The client sends this status information to the task server. Use of this status information can be used to prevent a flood of communications from clients at the same time. A user can monitor the progress of his or her account, select which projects to participate in, and watch on the system web site the standing of any team he or she might create or join.

As an optional feature, the client 200 may also provide a screen saver that reflects the activity of the distributed computing system and/or the activity of the individual client computer. This screen saver preferably does not itself do the computing. Again, such a screen saver is optional and the client 200 will run with or without it.

The client 200 preferably includes a report machine profile feature. The client uses this feature to report the user's machine profile to the task server. Specifically, once the client is installed, it preferably collects and reports information regarding the available memory and processor in the user's machine. Using this information, the task server 1200 can perform intelligent assignment allocation. The task server 1200 performs intelligent assignment allocation based on the strength and profile of the user machine.

Preferably, the client 200 requests work rather than being given a task. In other words, the client 200 preferably requests or asks for work rather than receiving a start message from a server.

A client 200 can preferably control a running task before its completion. As discussed below, the client can perform “Save Checkpoint”, “Exit Immediately”, “Exit After Next Checkpoint”, “Suspend” and “Resume” commands. Additionally, the client may perform “interrupt task” and “resume interrupted task” commands.

A client 200 is preferably able to detect when a network connection is not operating properly. In this scenario the client can attempt to contact the network with a “start to slow down” or “back-off” strategy, and then ultimately goes to a very low periodic checking to try to reconnect. And then when it reestablishes its connection it resumes the normal high-speed rate. This prevents the task servers from being “saturated” when they are again available because the rate of incoming connections from clients are stretched out.

When a client reestablishes a connection with the network, the client preferably automatically seeks the nearest server. Since the network preferably comprises multiple systems co-located around the Internet, the client software preferably first determines which of these systems (or servers) is closest to it, and then in the absence of that one being available, then find the next closest one automatically, as needed, in association with the back-off strategy. By way of example, this operation can be performed by the client acquiring an initial list of machines (servers) in increasing degree of distance away in internet space. And failing the connection with the first one, it will try the second, and so on.

The client 200 preferably also includes an LRU or Least-Recently-Used collection of the application software that it actually runs. There is more than one of these and each time the client wants to do a different kind of task, it uses a small piece of code that is unique to that particular computational task. The client keeps a reasonably sized collection of these pieces of code on hand so that when it wants to go from one to the next, quickly, there is no software download necessary in order for it to change. The client would write it on the computer disk and keep it there, if the client has recently used part of it. If it turns out that the client keeps going and getting new things, eventually the piece of code it uses the least often gets thrown away to make space for the new ones.

Several key markets exhibit insatiable appetites for computing. Some of these key markets are: biotechnology, digital image rendering, financial modeling, testing, and Monte Carlo scientific and engineering simulation. Additional computing power can improve application results without application software change. The computing applications in these markets will be well suited to a network-distributed computing system in accordance with the present invention.

By way of example, to motivate ISV partnering, a partner in each market can be selected with which to develop an application computing service and deliver that service at dramatically lower price. To develop new applications, computing resources can be donated to leading edge application incubators in the government and academic communities (National Science Foundation Supercomputing Centers) at the level of 10 to 100 million CPU hours (one thousand to twelve thousand machine years).

By using integration services, certified ISVs, an application innovator's program, ISP and client software distribution partnerships, a powerful new type of market can be developed, created and brokered. This new market is capable of disrupting the current supercomputing industry and redefining the standards for supercomputing applications for the Internet distributed computing model, instead of for the status quo bulky, costly big-iron boxes and racks.

The system described herein can grow by obtaining computing resources, i.e., home and business computers having idle time. The system can grow by capturing a significant fraction of machines on the entire Internet, and specifically those machines with broadband connectivity. In accordance with one aspect of the present invention, a large fraction of the total machines can be captured through incentives or compensation. For example, rewards may be given to users for a commitment of computing time. Incentives or rewards, such as frequent-flyer miles, etc., can be provided to users in return for a commitment of computing time on a user's computer for a certain period of time. Team compensation may also be used. For example, a team may win incentives or compensation for a commitment of computing time, or for achieving a certain team performance or team statistics, or for solving a problem first.

One exemplary distributed computing resource marketing strategy first targets small businesses and individual home PC owners. By way of example, several million initial machines can be acquired through application distribution channel partners and one or more of the following incentives: (1) a web site signup for free pre-IPO shares in a company in exchange for a commitment of machine time for a period of one year, and/or, (2) an offer of shares of stock purchased through cumulative machine time, that is, people earn shares in a company by contributing their machine time, and/or, (3) cash payment of machine time, as credit card charge-backs, and/or, (4) frequent-flyer miles, and/or, (5) opting for improving their odds in periodic prize drawings, and/or, (6) “green stamp” points redeemable elsewhere, such as for MP3 music, or donations online, or product coupons via online stores, such as for example book coupons from Amazon.com™.

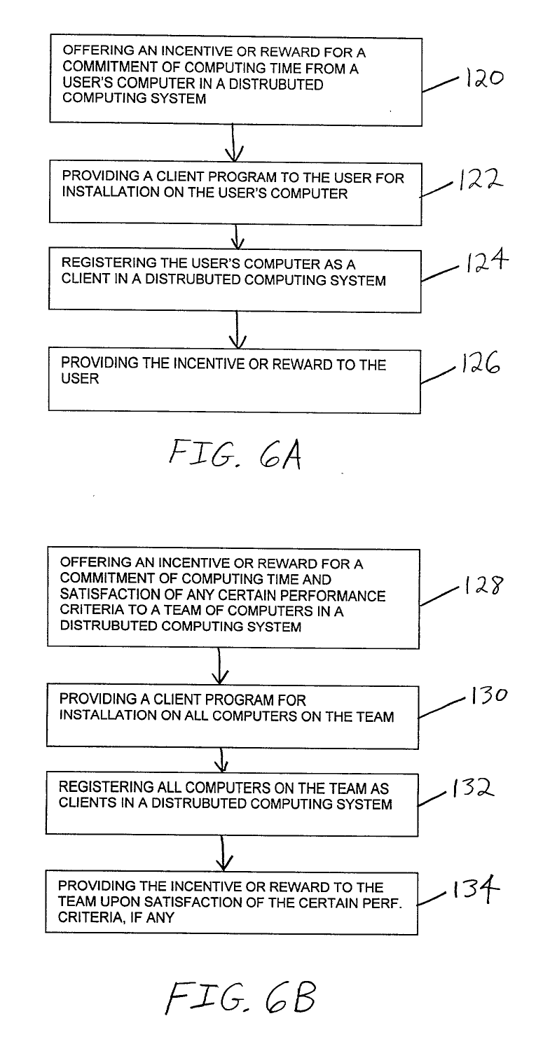

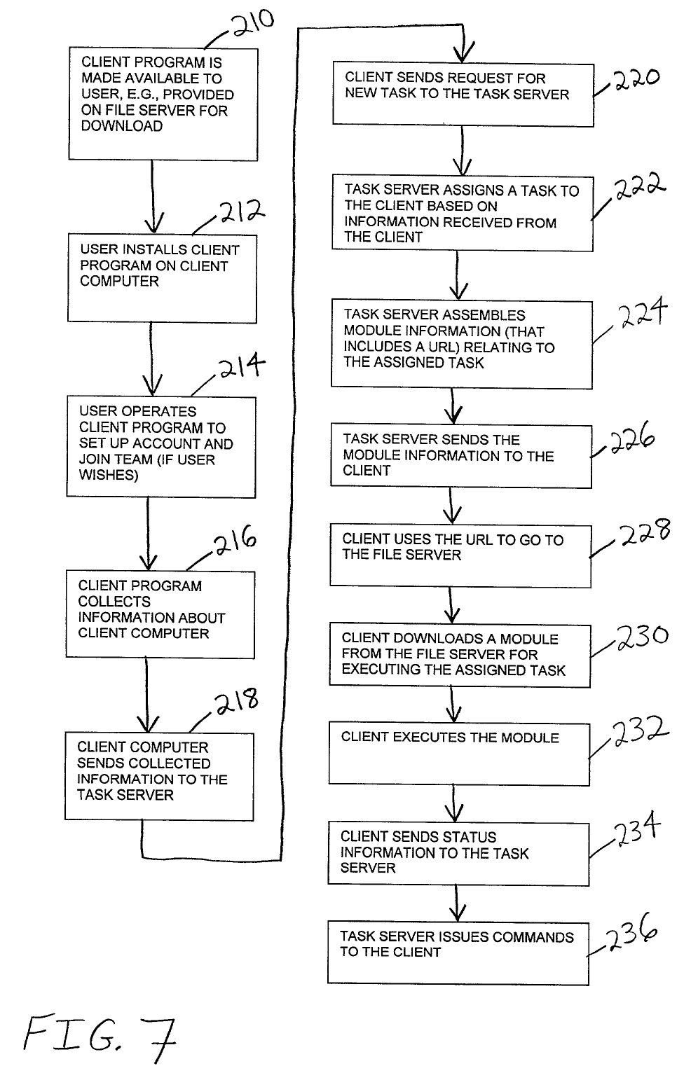

FIG. 6A illustrates an exemplary process for providing incentives in accordance with one embodiment of the present invention. In step 120 an incentive or reward is offered for a commitment of computing time from a user's computer in the distributed computing system 100. In step 122 the user is provided a client program for installation on the user's computer. Exemplary versions of this client program or client software is thoroughly described below. In step 124 the user's computer is registered or setup as a client in the distributed computing system 100. The incentive is provided to the user in step 126. The incentive may be provided to the user upon completion of the committed amount of computing time in the distributed computing system, or immediately upon the user's computer being registered or setup as a client in the distributed computing system 100.

With respect to team compensation, FIG. 6B illustrates another exemplary process for providing incentives in accordance with one embodiment of the present invention. In step 128 an incentive or reward is offered for a commitment of computing time from the users of a team of computers. The offer may include that the team satisfy certain performance criteria. In step 130 a client program is provided for installation on all computers on the team. In step 132 all computers on the team are registered or setup as clients in the distributed computing system 100. The incentive or reward is provided to the team in step 134. Again, the incentive may be conditioned on the satisfaction of certain performance criteria by the team. It should be understood that several embodiments of the present invention do not require that all steps shown in FIGS. 6A and 6B be performed or that the steps be performed in the listed order.

By way of example, strategic alliances may be used to deploy a distributed computing system of the type described herein. A mix of distribution channels can provide the advantages of rapidly developing a strong market share among our competition.

For example, network deployment channels may be used. Business partnerships can be developed with DSL, cable modem, wireless and popular large Internet service providers for local points-of-presence. From a network architecture standpoint, these enterprises support large numbers of highly connected computers on fast network lines. Computers that are less than three years old on these ISPs will preferably comprise the core revenue-generating resource for the system.

A partial list of specific proposed channel partners for deploying a network of the type described herein may include, for example: Major ISPs and Internet portals. Ongoing revenue sharing agreements may be used with major ISPs and portals.

Software distribution channels may be used. Developing business partnerships with PC manufacturers can provide for successful distribution of client software. Software that implements the functions described herein can be bundled as an installation option on several popular PC systems.

By way of example, a partial list of specific proposed channel partners for distribution of free client software include: PC manufacturers; Major ISPs; Internet portals.

Computer owner incentives channels may be used. Business partnerships can be developed with companies seeking referral promotions, where possible at no cost. By way of example, computer owners participating on a distributed computing system network of a type described herein may earn each month virtual coupons for a few dollars off e-commerce purchases, frequent flyer miles, or other incentives. The most productive computers (machine speed, availability & network speed) preferably earn larger incentives. Long-term loyalty might be encouraged through earning a company's stock. By way of example, these programs can be administered through partnerships with companies specializing in incentives and awards, which provide an avenue for people to spend their electronic earnings.

Sales channels may be used, i.e., the service described herein can be sold through several channels. The distribution channels may, for example, include strategic partnerships, certified service ISVs in target markets, and conventional supercomputer companies through negotiated revenue sharing agreements. Direct channels may, for example, include public auctions/direct sales to Industry, Business, Government and Academic clientele for market expansion made possible with a low price point.

A sales strategy may be used. Because of the special customer market characteristics (small number of early adopters with million dollar computing budgets), one exemplary sales strategy includes a two-pronged approach with both strategic ISV partnerships for initial sales and a direct sales force. The direct sales force may specifically target these customers for market expansion using a lower price point.

By way of example, public sponsorship auctions of low-priority distributed computing network bandwidth to support non-profit organization (NPO) research supercomputing customers enables them to use the distributed computing services in the absence of other work for the network. This can ensure that the network is always fully engaged, never idle. Private and corporate donations to NPOs acquired through auctions will enable them to pay for their network time. The distributed computing resource market is not a sales target per se, however the visibility from public relations, NPO beneficiaries and computing resource marketing campaigns can help to drive and increase customer market awareness.

What follows is a description of the functionality of one exemplary version of a client 200 made in accordance with one embodiment of the present invention. While the invention herein disclosed is described by the specific embodiments and applications described, it should be well understood that numerous modifications and variations could be made thereto by those skilled in the art without departing from the scope of the invention.

The client 200 is preferably configured to run with Microsoft Internet Explorer IE 4.01 or later version or Netscape Navigator 4.x version or later version. It should be well understood, however, that other Internet browsers may be used with the present invention. With respect to platform support, the client described herein preferably supports Windows NT 4.0 Workstation, Windows NT 4.0 Server, Windows 98, and Windows 95, and Windows 2000. Later versions of these platforms, as well as other platforms, may be supported. The client runs on the user machine and is preferably a Win32 client, but this is not required. As described below, a program referred to as UpgradeMe.EXE may be used and is a helper application that upgrades the client whenever invoked. Preferably, a Task Server Flexible Engine supports a flexible mechanism whereby a web-client (the client in this case) can call stored procedures in a database such as MS SQL Server 7.0 database. Any new stored procedures that are added will require no code change in the Task Server Engine.

The client 200 preferably runs on home and office computers of various models, profiles, connectivity and availability, and provides the raw computing resources of the virtual machine network described herein. The deployment picture for a client along with the servers is intended to achieve a highly distributed environment where very large computation intensive tasks are broken down into thousands of sub-tasks and then distributed to thousands of clients running on a variety of computers across the Internet. One goal is to use the idle CPU time of each of these thousands of computers to perform these computations. Therefore, one of the main responsibilities of a client 200 is to run custom application modules on a user's computer in a low priority so any idle CPU time is taken up by the client. These application modules are obtained (downloaded) from servers along with information about the task. The client uses the task information to control the execution of these modules. Application Modules are also referred to herein as Computation Modules.

The client 200 preferably communicates to three different kinds of servers for performing its operations. Referring again to FIG. 3, they are a Task Server 1200, an Application Server 1300, and a File Server 1100. The Task Server 1200 contains information about which client should perform which task. It also keeps track of the status of these tasks on all the clients. A client communicates to this server for any task related information or status. The Task Server may be invoked through a web server (IIS 4.0 or later) and is preferably implemented as Active Server Pages or ISAPI filters along with ActiveX components.

Regarding the Application Server 1300, since each application module is likely to be very different from another application module, the application server keeps any module specific information, including providing any custom input to the module or receiving any output from the module. An application server may handle more than one type of application module or it may be dedicated to only one kind of application module. The application server may be invoked through a web server (IIS 4.0 or later) and is preferably implemented as Active Server Pages or ISAPI filters along with ActiveX components.

The File Server 1100 contains any downloadable modules or software upgrades that the client might require. The File Server may be invoked through a web server (IIS 4.0 or later) and is preferably implemented as Active Server Pages or ISAP filters.

FIG. 7 illustrates an exemplary process for operating a client in a distributed computing system in accordance with one embodiment of the present invention. It should be understood that several embodiments of the present invention do not require that all steps shown in FIG. 7 be performed or that the steps be performed in the listed order.

The client program or software is made available to potential users in step 210. An InstalShield based installation program may be used for the first-time installation of the client. This is preferably a self-extracting EXE which the user will download and then run. Upon running, it will automatically and easily install the client on user's machine, as indicated in step 212. An installation program for the client upgrade may be invoked by UpgradeMe.EXE to upgrade the client software without requiring any user intervention.

With respect to installation 212 of the client 200, InstallShield may be used to display a sequence of steps the user proceeds through to install the client software onto a PC. By way of example, a user may start the ClientSetup.exe program, an initial splash screen is displayed, and the user clicks “next”. The program information and End User License Agreement is displayed, the user reads and clicks Yes to acknowledge agreement. The setup program checks for previous versions of the software, and if found, automatically selects that location and displays a warning that the client software updates itself and should not be reinstalled unless directed by trained technical support staff. The setup program asks the user to specify a software install location and how much temporary data file space (in percent of disk size, initially suggests 2%) can be used by the client (discussed below). The setup program verifies there is sufficient disk space on the selected disk location and allows user to change location if there is not enough space. The setup program copies files and applies settings, then displays that installation is completed. The user clicks Finish to configure and start the client.

In step 214 the user operates the client to set up an account. The following discussion focuses on what functionality the client provides in one exemplary embodiment. Some of the functionality is visible through the GUI while some of the functionality is hidden from the user and is performed in the background.

Regarding network settings, there are at least three situations that the client would face when it comes to connectivity with the Internet. They are: a dialup networking based connection; a LAN connection which is always up; and AOL (America On-Line™) based connections. The client preferably supports all of these connections, but support of all three is not required, and other types of connections may be supported. In a dialup networking connection, the client will preferably be able to detect whether a connection has already been established or not.

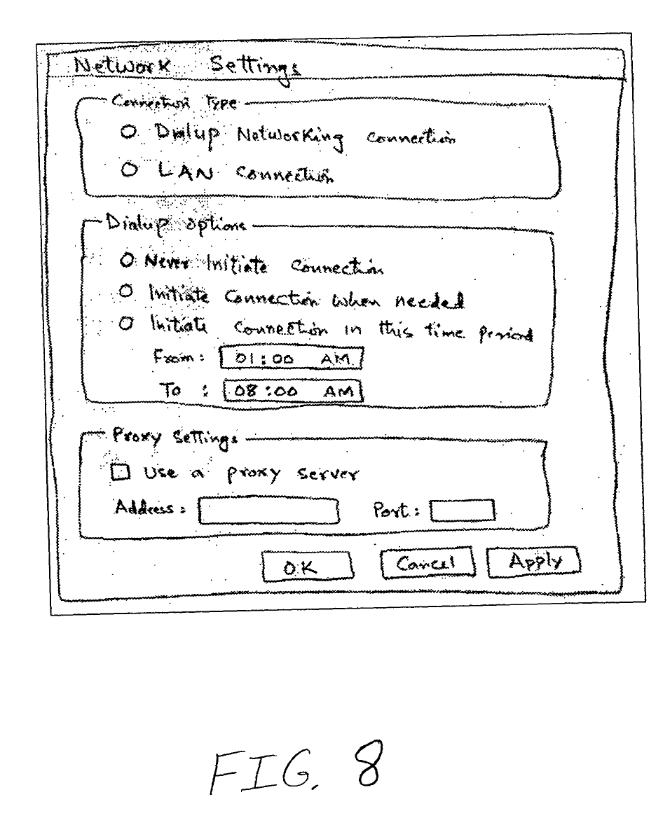

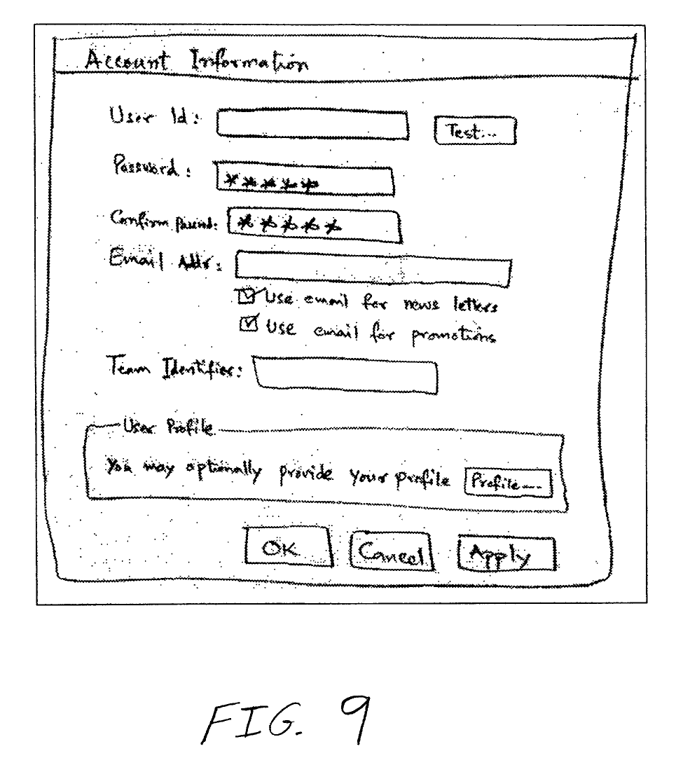

FIG. 8 illustrates an exemplary network settings dialog box that may be used with the client 200. For a dialup connection, the client preferably assumes that the user has already setup a modem and has created an entry in the dialup networking. The client preferably does not facilitate any definition of the dialup networking connection. Independent of whether a connection is through dialup networking or LAN, there may be a proxy server through which the connection to the Internet is established. The client preferably gives the user an option to specify proxy server address and port number.

FIG. 9 illustrates an exemplary account information setup dialog box that may be used with the client 200. After the user has setup and configured the client for their network, they would need to go through and setup account information. The user preferably specifies the following information at the account setup time:

User Id: This is preferably a user id that is generated by a Task Server and is unique in the system. The client will need to connect with the Task Server to verify that this User Id is actually unique. If this is not unique, then Task Server will suggest a unique User Id that is similar to what the user has entered. The user can either accept this unique User Id or try another one of their own preference. If they specify another one, then the client checks again with the Task Server.

Password: When the user types this information, the ‘*’ characters preferably appear.

Confirm Password: To make sure the user has entered a password they really wanted to, they are asked to type it again as a confirmation. When the user types this information, the ‘*’ characters preferably appear.

Email Address.

Use email for new letters? This is a check-box.

Use email for promotions? This is a check-box.

Team identifier: This is an additional piece of information to help group different kinds of users. This is only a name.

The illustrated user profile setup feature is optional. If the user presses the “Profile . . . ” button, they are presented with another dialog where they can enter all the profile. Then, this information is sent to the Task Server 1200 at an appropriate time in the communication between the client 200 and the Task Server 1200. Some of the information that the user can enter as part of their profile is as following: First Name, Middle Initial, Last Name; Country/Region; State; Zip Code; Time Zone; Gender; Age; Occupation. Other information may be included.

In steps 216 and 218, the client 200 preferably automatically collects the following machine information and sends it to the Task Server 1200. In fact, every time the client 200 is restarted, it preferably checks for the machine information in case it has been changed. This machine information is very useful because the Task Server 1200 can do intelligent assignment allocation based on the strength and profile of the user machine. Preferably, the following machine information is gathered:

Unique GUID: Also referred to as Unique Machine GUID or Unique Machine ID, this GUID is preferably automatically generated the first time the client is launched on a machine. Even if the entire directory structure is copied to a different computer, the client is preferably able to detect that it has never been run on this machine (perhaps by keeping this information in the Windows registry) and generate a unique GUID. The GUID is eventually sent to the Task Server 1200, and the Task Server 1200 preferably then sends a unique “short” machine ID back to the client to use in subsequent transactions.

CPU Model: Whether it is Pentium, Pentium Pro, Pentium II, Pentium III, or others.

Operating System: Windows NT 4.0, Windows 95, Windows 98, Windows 2000, or others.

CPU Speed in Mhz: This information might change if the user upgrades the machine.

Available RAM: This information might change over time if the user upgrades the machine.

Network Speed to Task Server: The client can preferably send a PING to the Task Server and determine how much time it takes to get an acknowledgement. This information is captured and sent to the server later. This information will also change if the user moves from a dialup to a LAN or from a slower LAN to a faster LAN. The client does not attempt this test if the dialup connection is down and user settings have specified that the client should not initiate a dialup connection.

The above machine information is also stored locally in registry and updated whenever new information is available. Every time machine information changes from the last check, the client 200 sends the information to the task server 1200. If the connection to the server is down, this information is saved locally and sent when the connection is available.

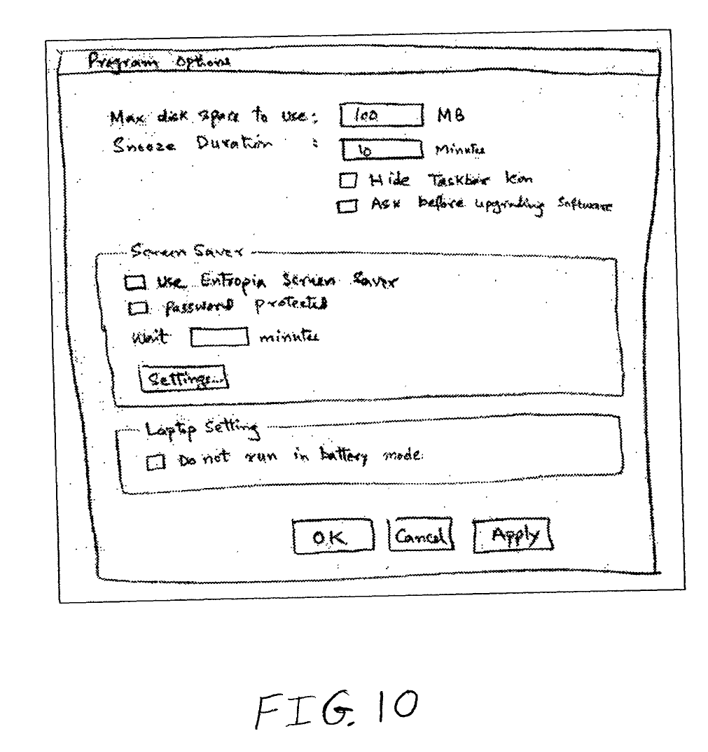

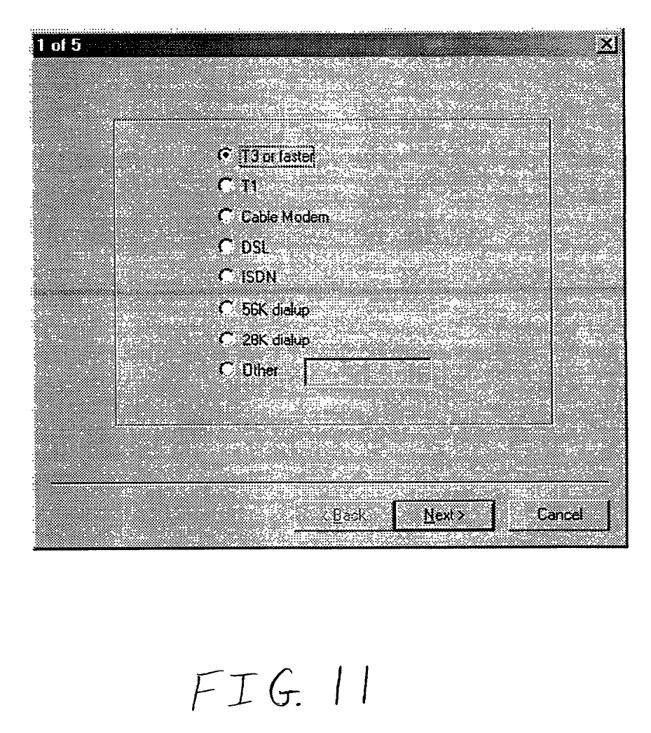

As part of the setup process, the user is preferably able to specify various options/preferences (program options) for the client behavior. FIG. 10 illustrates an exemplary program options dialog box that may be used with the client 200. The options preferably include:

Maximum disk space to use: If the user specifies this then the client will ensure that this limit is not exceeded.

Snooze duration: One of the things the user is able to do is to put the client to a Snooze (meaning temporary sleep). The user can specify here how long that sleep should be. There is preferably a default value provided here, perhaps 10 minutes which can be changed.

Use Special Screen Saver: A special screen saver can be used that is aware of the client activity. The user can activate it from here. The user can also go to DESKTOP->PROPERTIES and make the special screen saver the default one. The client will detect that and automatically turn this option on if the user has setup the special screen saver even from the Display->Properties.

Hide Taskbar icon: The user may not want to see the small icon on the left-bottom of their screen. This option will allow that. Then, the user will have to go to the client menu and invoke the application again to re-enable the taskbar icon.

Ask me before upgrading automatically (default=No).

Directories for data storage: The client preferably keeps a folder under which all the data that cannot be saved in the registry (meaning it is either coming from the application module or is task related). By default, this directory is in the same location as the client's program files. However, the user can specify a different location in case they are having disk space problems etc.

Laptop settings, such as don't run on battery mode: The client preferably detects that it is installed on a Laptop and the laptop is currently running on the battery. If this option is turned on then the client will put itself to a Longer Snooze.

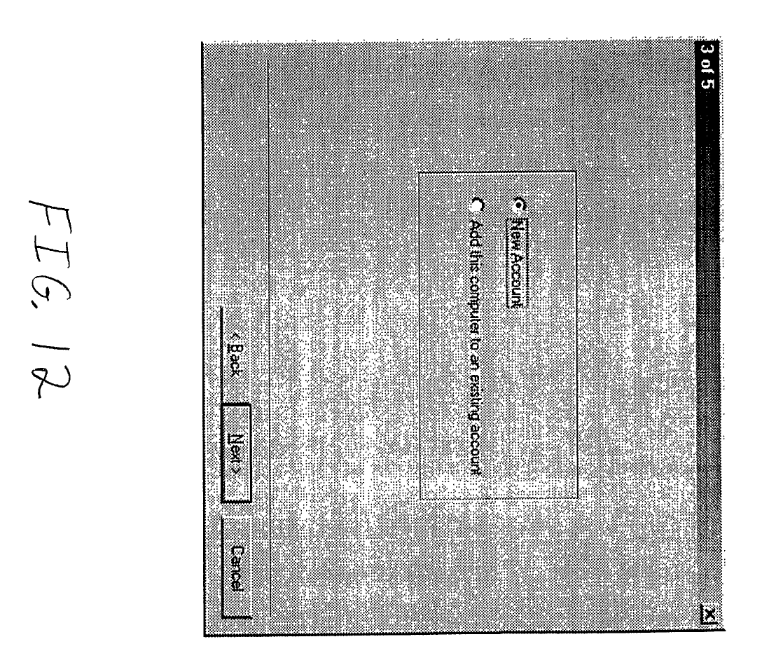

With respect to configuration of the client 200, the desktop client software is preferably self-configuring the first time it is run. Normally the first time it will be run will be when the installation Setup program starts it as the last step of installation. There is a preferred sequence of configuration steps the user proceeds through to configure the software for use on the distributed computing system network. Referring to FIG. 11, the user is prompted to select a network connection type, DS3/T3 or faster, DS1/T1, Cablemodem, DSL, ISDN, 56k dialup, 28k dialup, other (which the user specifies). Preferably, only one option can be selected. Then the user clicks “next”. Next, as mentioned above, the user is prompted for the percentage of disk space the client can use for its application module work space. Preferably, the default is 2%. The user can choose up to 100% or as little as 1%.

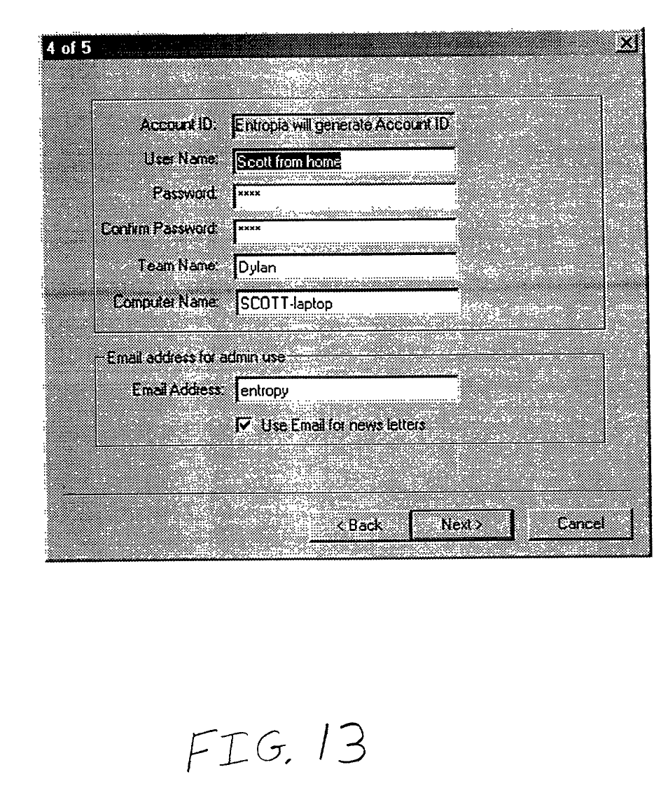

Referring to FIG. 12, the account registration step prompts the user to specify if that computer is being added to an existing account, or creating a new account. The account is information about the choices configured by the user, which machines they have added, and how many hours those machines have produced in computing time. Preferably, this information is kept on the network servers, not on the PC.

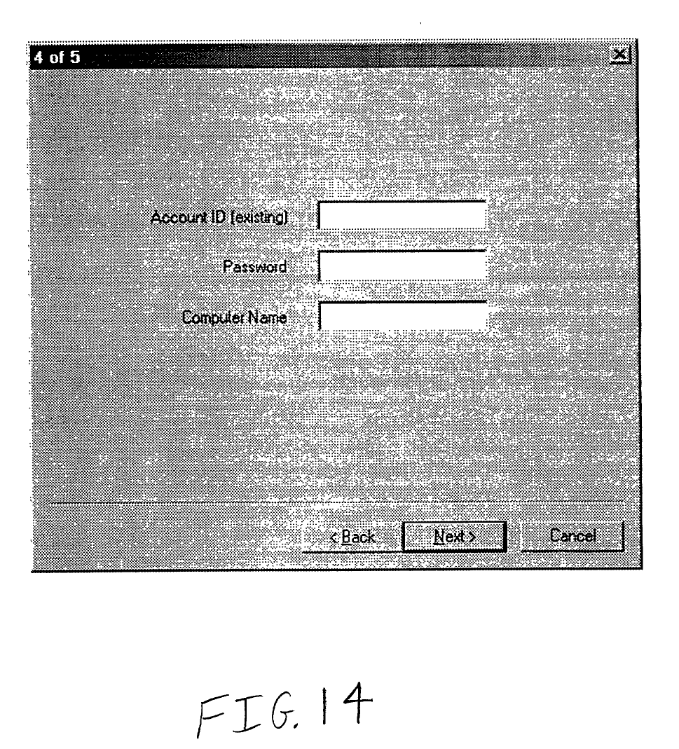

The following step is different for new accounts and existing accounts. Referring to FIG. 13, for New Accounts ONLY, the user is preferably prompted to enter:

A human-friendly name for the account that can appear on the system's web site for performance statistics; this is not the account identifier, just the account holder's self-described name (which is unrestricted).

A password for the account, and a verification of the password. The password characters are not displayed, but rather asterisks (‘*’) are shown for each character as they are typed for these fields.

An optional, human friendly team name to join or create. Teams allow many different accounts to pool their productivity statistics into a single group that appears on a competitive ranking on the system web site. Team names are unrestricted.

An email address is required for administration of the network, but will normally not be used except for support or emergency reasons.

An opt-in selection to receive emailed newsletters using the email address entered. A use for promotions option may also be included.

A human-friendly computer name (not shown below) that is automatically initialized to the network name of the PC.

The user can edit/change or clear this computer name field.

When the user clicks Next, the software contacts the system network. If the user entered a team name, it checks to see if that team exists. If the team name exists, the user is prompted with a dialog “This team already exists. Do you wish to join this team?” with a Yes/Back button combo. If the team does not exist, the user is prompted with a dialog “This team does not exist. Create a new team?” with a Yes/Back bottom combo. If the user clicks Back, they can change the team name or clear it to not participate in a team. (The user can later associate themselves with a team on the system's web site.).

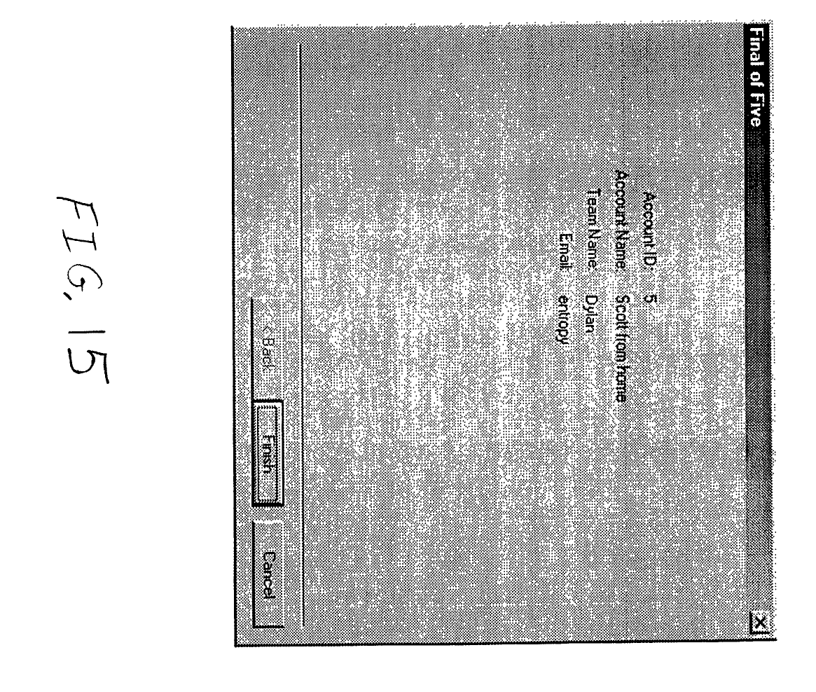

Referring to FIG. 14, for Existing Accounts Only, the user is prompted to enter the unique account ID provided by the distributed computing system network and password provided by the user during a previous software setup. This feature allows multiple computers to participate on a single account, pooling their machine time statistics. An example account for a family may have all the computers in the home on one account; a business office may have all the computers in the company on one account; a group of friends may be on one account, etc. By way of example, if compensation is provided for computer time, the account owners can be compensated.

The user may also enter a human-friendly computer name that is automatically initialized to the network name of the PC. The user can edit/change or clear this computer name field.

If the user clicks “Next” at this point, the software contacts the system network to register the computer and account information with the network servers. For new accounts, the network servers will create a unique account ID and send it back to the client software. For existing accounts, the account ID and password are validated against the existing account and an error may be reported if they do not match, at which point they may click Back, and re-enter the account ID and password information.

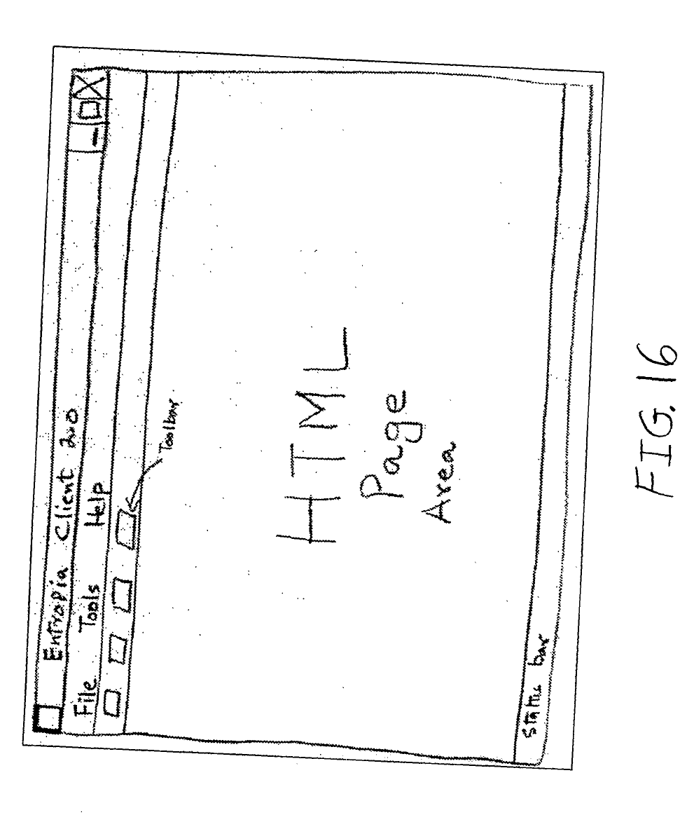

Referring to FIG. 15, the successful registration of a new computer onto the distributed computing system network will then display a summary of the information for the account and computer, which may include: Account ID; Human friendly Name on the account; Network connection type; and Human friendly Computer Name. The user clicks Finish at this point to exit the configuration process.

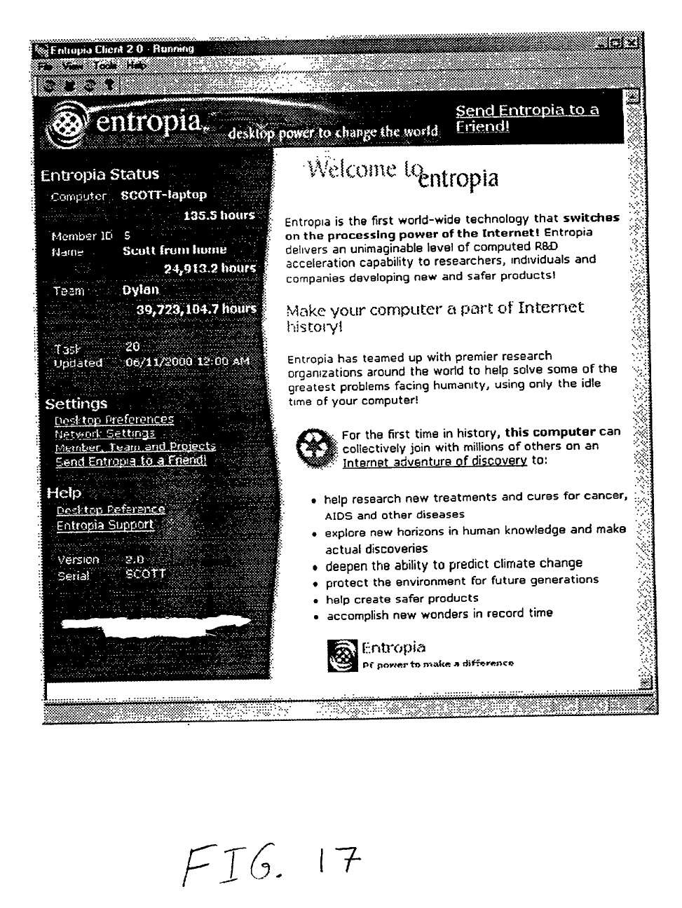

Referring to FIG. 16, as mentioned above, the client 200 preferably includes an HTML page viewed in the background. Although, most of the time the client application stays minimized on the bottom-left of the screen, the user is able to restore it. When the application is invoked, it will be an SDI application with a menu bar, a tool bar, and a client-area. The client-area is usually a blank space and therefore is wasted. Preferably, however, in the client, the client-area is actually an HTML control that can display any IE 3.01 compatible HTML page. This way, the system can make valuable information available there including hyperlinks to the system website, etc. If the user presses any hyper-link from this page, it will open up that HTML page in the user's standard browser. This HTML file is downloaded whenever the client reboots and then connects to the server. If it finds a newer HTML page, it downloads it and then displays it. The HTML background page will be discussed in more detail below.

The client 200 preferably includes certain user commands. Since the client is running on a user's machine and is taking up CPU time, the user preferably needs to have the ability to control certain aspects of the application whenever they wish to. The user has the ability to either go into a menu of the client or use the right-mouse click on the bottom-right task-bar and use a pop-up menu. From either of these ways, the following commands are preferably available to the user.

Disable Command: When the user selects this option, the client suspends the execution of its application module or any communication with any of the servers. However, the program is not terminated and instead only suspends itself until the user Enables it again. Once the program is disabled, the Disable menu-option becomes disable itself.

Enable Command: This menu option is usually disabled and is enabled only when the user Disables the application. At that time, this menu option becomes active. Then, when the user selects this menu option, it resumes the execution of the application module in the same way it was executing before it was Disabled by the user.

Snooze Command: If the user wants to do something that requires CPU and/or memory and they do not want the client to be interfering, they can select the Snooze menu item. This option disables the execution of the application modules or any interaction with the serve for a specified period of time. The duration of this period is specified through the Program Options discussed earlier in this document. After that period, the client automatically resumes its operations normally.

Exit Command: If the user selects this menu-option, the client immediately exits. However, before exiting, it terminates all application module executions or any interaction with the server. It attempts to save some state information to the disk that can be read later when the client is invoked again.

Help Command: When the user selects this option, their standard browser is invoked with an HTML file displayed. This HTML file is stored locally on the disk and contains basic helpful information. For any detailed help information, there are hyperlinks available in this page that point to the system's help URLs. By having a local HTML file, the user is provided with some basic useful help information without requiring them to access the Internet and obtain it from the system website.

Help About Command: When the user selects this menu-option, they are displayed a standard Model dialog which contains information about the client, its version, the system, their contact information, and more. There is an OK button which when pressed closes the About Dialog.

The client 200 preferably has the ability to work in a disconnected environment. Specifically, one of the important features the client preferably includes is the ability to know whether the computer is connected to Internet at a given time or not. If a computer is not connected to the Internet then the client can initiate an Internet connection if the user has given it that permission. However, if the user has not given this permission (discussed in the Network settings section) then the client has no option but to wait until the user itself is connected to the network.

If a network connection cannot be established then any information that has just been generated to be sent to the server has to be queued up for a later transmission. This is true for the main client and its application module both of which are able to send information to the Task Server or the Application Server.

In a disconnected situation, the client preferably needs to make sure that none of the information that would otherwise have been sent to the server immediately is lost. Therefore, all that information is saved to the local disk. Similarly, the application module preferably needs to also inquire from the client whether a given time is good for sending information to the server. And, if the client determines otherwise then the application module also saves all its information to the local disk and sends it later when the network connection is live.

When the client detects that the network connection is live again, it sends all of its own queued information to the server. It then informs its application module(s) that they can do the same. The client preferably has a mechanism of knowing exactly which information from the queue has been sent before the network connection is terminated perhaps by the user. This way, the next time the network connection is available the rest of the things in the queue (and maybe even new ones) are sent to the server. The same rule applies to the application module.

As mentioned above, the client 200 preferably requests tasks from the Task Server 1200. At appropriate times in the client's execution, it may decide that its current task is finished and it needs to obtain a new task from the Task Server 1200. In step 220 (FIG. 7), the client 200 issues a request to the Task Server 1200 asking for a new task. This task may be further computation on one of the already existing application modules that the client has cached locally on the disk or it may require the download of a completely new application module. In either case, when the request is sent to the Task Server, the following information is preferably provided which assists the Task Server 1200 in assigning the most appropriate task to the client: Unique machine GUID; CPU number (optional: default is zero); User Id. Regarding the CPU number, if there are more than one processors then the client preferably needs to inform the Task Server which CPU needs the next task. This is because there might be different kinds of tasks running on different CPUs and this information would help the Task Server determine what is the next appropriate task assignment for the client. As mentioned above, application modules are also referred to herein as computation modules, computational modules, task modules, and/or simply modules. In return, in step 222 the Task Server 1200 assigns a task to the client 200 based on information received from the client 200. In step 224 the Task Server 1200 assembles module information relating to the assigned task and sends this module information to the client 200 in step 226. Specifically, the Task Server 1200 sends back the following information to the client 200 which the client needs to determine how it can run the next task: Unique Computational Module ID; Computational Module version number; URL to get the Computation Module if it is not already cached locally; and Checksum for computation module binary files to make sure they are still valid after being downloaded.

Once a unique Computational Module ID and its corresponding URL is obtained from the Task Server 1200, the client 200 is ready to talk to the File Server 1100. Even if the Computation Module (or application module) is cached to the local disk, the client might still download it from the File Server 1100 because the version number of the cached copy might be older.

In step 228 the client 200 uses the Computation Module URL to go to the File Server 1100, and in step 230 the client 200 downloads a self-extracting EXE file. This file is preferably downloaded in the WINDOWS\TEMP folder based on the environment of the computer. Then, the checksum obtained earlier from the Task Server 1200 is compared with the checksum of this self extracting EXE file. If it appears valid, then, the self extracting EXE is run and all its files are extracted in, for example, a WINDOWS\TEMP\ENTROPIA folder. Then, these module files which are most likely DLLs are copied to the appropriate module folder based on the ModuleID and its version number. In this way the client 200 downloads a Task Module (or computation or application module).

Then, finally, the older version of the Module is deleted from the local disk if it is present there. A Least Recently Used (LRU) algorithm is used to determine which other module needs to be deleted from the local cache in order to make room for this newly downloaded module.

With respect to running a task, once a new task is obtained and its corresponding module files are either already present on the local disk or they have been downloaded from the File Server, the task is ready to run. Every computational module preferably adheres to a known protocol (API) regardless of what is the logic of its computation. This allows the client to interface with this module dynamically and control it in a standard fashion. So, after ensuring that the module files are available and all the task related information has been obtained, in step 232 the client 200 starts the task to run parallel to the client which has to do other administrative tasks as described in this document. After a task has been successfully started and does not return a failure status back to the client, the client 200 informs the Task Server 1200 about this so the Task Server knows when a given task was started on a given machine.

The client is preferably able to communicate with the Task Module. Specifically, after a task has been started, the client is still able to control various things in this task. In one of the previous sections, User Commands were described. Most of those commands end up affecting the running task(s). Additionally, the Task Server 1200 can issue various commands to the client 200 about what should happen to a given task, as indicated by step 236. The client 200 therefore needs to be able to control the running task even before its completion.

The client 200 can preferably do the following things to the task:

Save Checkpoint: When the client asks the Computation Module to Save Checkpoint, it is actually asking it to find the next appropriate time when its information can be saved to the disk in such a fashion that if it were terminated and restarted, it would be able to start from this checkpoint. However, whether a computational module is actually able to do this or not depends entire on the module. The client has no way of verifying that the checkpoint has actually been saved.

Exit Immediately: If something urgent is happening, the client can inform the Module to immediately save whatever it can and then exit. This means that every module needs to constantly look for such commands coming from the client so it can quickly respond. If the computational module is not able to save anything immediately, it will still terminate and then if it is restarted it will start from its previous checkpoint or from the beginning of the task.

Exit After Next Checkpoint: In this scenario, the Computation Module waits until it reaches a stage where it can save all of its information to the local disk and exit in such a way that if it is restarted it would restart from that point forward. If the module does not have the ability to save checkpoints then it can either exit immediately thereby losing all of its computation done so far or it can wait until the completion of its task. This can be user-specified or the module can determine which is the better of the two options to choose from.

Suspend: In this situation, the client informs the computational module to suspend its operations but not exit. The computational module goes to sleep (stops taking any more CPU time) until the client wakes it up. If the module feels that it can immediately save checkpoint information to the disk it may prefer to do so in case it is not resumed and instead terminated. However, if this information is not easily available then it simply goes to sleep. Then, when the module is woken up by the client, it resumes its work from where it was suspended.

Resume: If a module has been suspended then it can be resumed by the client. As soon as the module is resumed, it starts its computation from where it was suspended.

Additionally, the client 200 may perform “interrupt task” and “resume interrupted task” commands.

The client 200 is preferably capable of sending status information to the Task Server 1200. Specifically, at various points in time, the client 200 sends status information to the Task Server 1200 so the Task Server is aware of what is happening to each client. This is indicated by step 234. A status update to the server needs to wait a minimum time interval plus a random time interval between sending status update messages to the server. This is to prevent a flood of communications from clients at the same time, which could bring down the server. The minimum time interval will be determined by which state the task manger is in. In addition, if a status update needs to be sent, the client cannot transition into the next state until this time interval has passed, and the status update message has been sent.

Whenever status update is sent to the Task Server 1200, it preferably contains the following information: Unique machine GUID; CPU number (optional: default is zero); Current version of the client; Current Module ID; Time stamp of last state change; Current state of the client for this module (this can have the following values: Just rebooted; Requesting a task; Downloading a task; Running a task; Polling for continuation; Finished a task); Error Information (which may include: Everything is OK; Exception in The client itself; Cannot load or run the module; Task finished without an error; Task finished with an error; Task was gracefully terminated; Task was not gracefully terminated); Result status of the last task terminated/completed; and Time when the last task terminated/completed.

The client 200 and the Application Modules (or Computation Modules) preferably collect performance data. The following data is preferably collected: Process clock time, actual thread CPU time (requires vxd on Win95/98); Paging statistics; and Disk statistics. The client collects this data from each running instance of the Application Module per reporting period (which can be an hour or when an application module is shut down) and preferably adds to that data information about: Total free memory of the machine; Network ping rate (or if the network connection is not active); Number of reboots in that reporting period. This data can be collected with a single data row per hour per CPU (maybe some redundant information for the general client appears in each CPU row per hour). The idea is that this data is sent perhaps once every 24 hours in a batch (how often is this sent must be a configuration parameter) and the size of the data should be only a few hundred bytes.

With respect to error handling, all exceptions that occur in the client 200 are preferably caught, if possible, in such a way that the user input is not required. If an error occurs, then at this point the current state of the client should preferably be stored locally, a status update sent to the server, and it should be communicated with the computational module that the client needs to be restarted. When the client is restarted, it preferably communicates with the Task Server 1200 and informs it about what has just happened. Additionally, as part of the reboot process the client will automatically check for a newer version of the software and if it is available then this version is upgraded through the upgrade program which is discussed later. Preferably, none of the error handling routines should display any error messages to the user or require any user input since the client is a background-running program and therefore must handle everything automatically.

As an optional feature, the client 200 may be configured to handle SMP machines. Specifically, for machines with multiple processors, multiple computational modules can be run in parallel, ideally one per processor. In this scenario, the client can detect the number of processors as part of the machine information and then send this information to the Task Server 1200. It can then ask the Task Server 1200 for more than one task to be run simultaneously (each task request is sent separately). If more than one computational module is running on an SMP machine, then the client handles all the modules the same way that it would handle a single module on a single-processor-machine.

The client 200 preferably has the ability to save data locally. Specifically, throughout the execution of the client, information is being generated which eventually needs to be sent to the Task Server. Similarly, the computational module is generating its own custom information that it would send to the Application Server. However, this information needs to also be saved locally at least for efficiency purposes so when enough information is gathered it can be sent at once thereby reducing the network traffic. Additionally, there are situations when the client 200 is working in a disconnected environment and cannot really send information to the Task Server 1200 or Application Server 1300. In this situation, the only option is to save this information to the local disk and then send it later when the connection is reestablished. The location of where all this information should be saved is preferably specified in the program options.

The client 200 preferably includes an automatic software upgrade feature. Specifically, every time the client reboots or reaches the completion of a task, it preferably inquires the Task Server 1200 whether a newer version of the client is available or not. The following information is preferably sent to the Task Server as part of this request: Unique machine GUID and Current version of the client. And, in return it receives the following information back from the Task Server: New version of the client; URL to get the new client installation program which is a self-extracting EXE; and Checksum for the self-extracting EXE to make sure it is still valid after being downloaded.

At this point in time, the client 200 takes help from a companion program which was preferably installed as part of the first-time installation. This program's purpose is to help upgrade the client and does not contain any other client like functionality. After invoking this program, the client exits and gives the control over to this upgrade program which does the following: put the upgrade program in the WINDOWS startup folder in case the machine is rebooted; remove the client from the startup folder since it is no longer the valid version; run the setup.exe that came with the installation program that would upgrade the client; when the setup.exe is successfully finished, remove the upgrade program from the WINDOWS startup folder and ensure that the client is back in the startup folder; and run the client and then exit itself.

With respect to first time installation, when the user signs up to participate in the distributed computing system 100, they preferably download an installation program to install the client 200 and its upgrade-helper program. This is preferably a standard Installshield program that is preferably available as a self-extracting EXE on the system website.

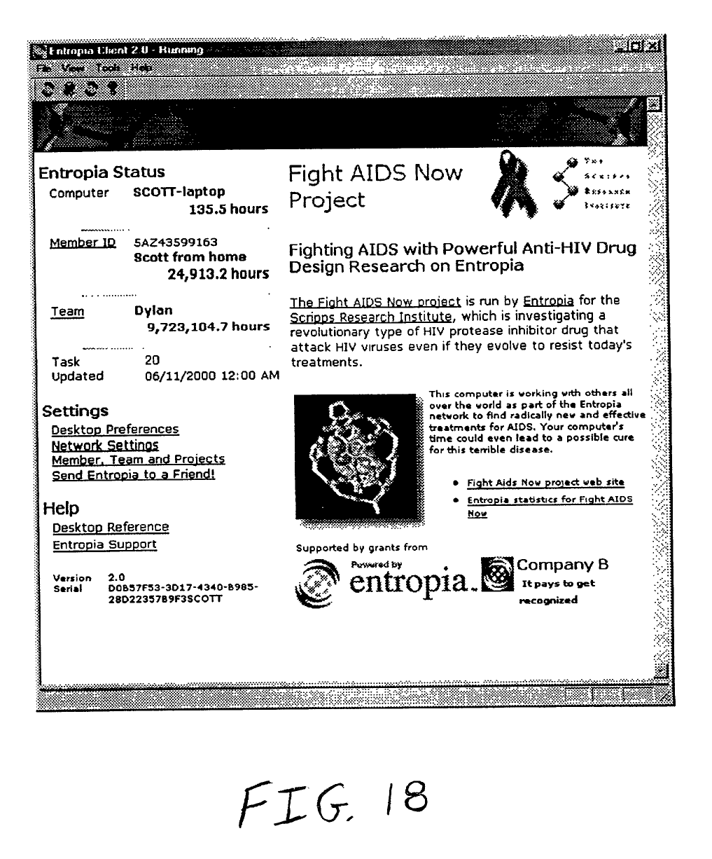

With respect to the HTML page viewed in the background of the client 200, referring to FIGS. 17 and 18, the Background Page preferably includes two main regions of the display, the desktop status section, and the application-specific web content section. The display as a whole is preferably an HTML window in which a combination of active elements that get information from the client software, and inactive graphics, text and HTML elements. This page as a whole is preferably customized for each application project the client software will run on a computer. Preferably, however, if there is no customized page for a software module a default page is displayed instead. The default page will most typically be used in this fashion whenever the distributed computing system performs internal network research or runs a commercial customer application.

The background page desktop status section preferably includes several items of information, which may include Status, Settings, and Help. For example, with respect to Status, the following items may be included: computer-specific name and performance information; member (account) specific ID, name and performance information; and optional affiliated Team name and performance information. With respect to Settings, the following items may be included: desktop preferences; network connection; member, team and projects (goes to system web site); and send to a Friend (formats an email message to send hyperlink). With respect to Help, the following items may be included: desktop reference; support (goes to system web site); and version & software serial number. A copyright notice may also be displayed.

The application-specific web content section contains web material. There may be a default style background page for default system and commercial applications. Any material including sponsor logos and slogans can appear here. FIG. 17 illustrates an example default view for a system and commercial applications. FIG. 18 illustrates an example view for AIDS drug discovery application.

The Status information provided on the background page may include computer-specific name and performance information. For example, a human-friendly name the person assigned to this computer can be displayed, and the number of actual CPU hours the machine has produced in total for the distributed computing system can be displayed.

The status information provided on the background page may also include Member (account) specific ID, name and performance information. For example, this can include the system-assigned member ID and the human-friendly publicly referenced member name (can be blank if they so choose) the person assigned to their system membership account. This name can preferably be updated on the system member's web site. More than one computer can belong to a single member, and the total CPU hours accumulated by all the machines in the member's account are preferably totaled and reported here.

The status information provided on the background page may also include optional affiliated Team name and performance information. For example, this can include the human-friendly public team name (if blank means no team affiliation) and CPU hours cumulative across all accounts that are affiliated. This affiliation can be changed on the system member's web site. When a member changes their team, the CPU hours for their account is subtracted from the former team, and added to the new team.

With respect to CPU time accounting, the “hours” figures reported preferably increment every 6 minutes by 0.1 hour. These figures are updated according to the following guidelines. The machine, account and team hours are retrieved from the Task Server 1200. As an application module executes, it tracks and reports to the client 200 the actual CPU time accumulated on that application module task. The client 200 periodically requests the value from the Application Module, and adds this value to the values retrieved from the Task Server 1200. At the end of the Application Module task, the Client 200 reports the final total CPU time produced by the Application Module to the Task Server 1200. The Task Server 1200 adds that amount to the totals for the machine, account, application, etc. This process repeats again, now with the hours retrieved from the Task Server 1200 reflecting the actual CPU time recently produced by the Application Module (plus any updates by other machines in the account, or other accounts in the Team).

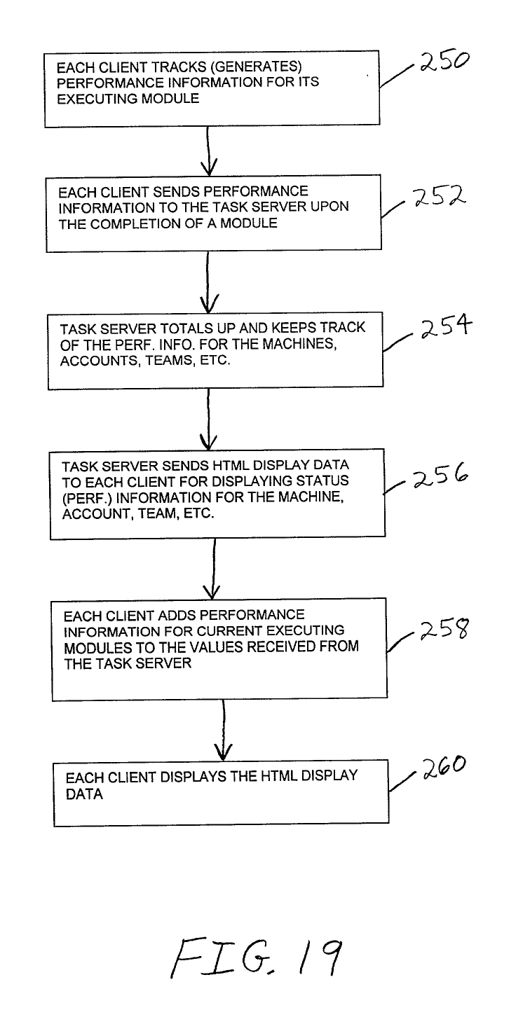

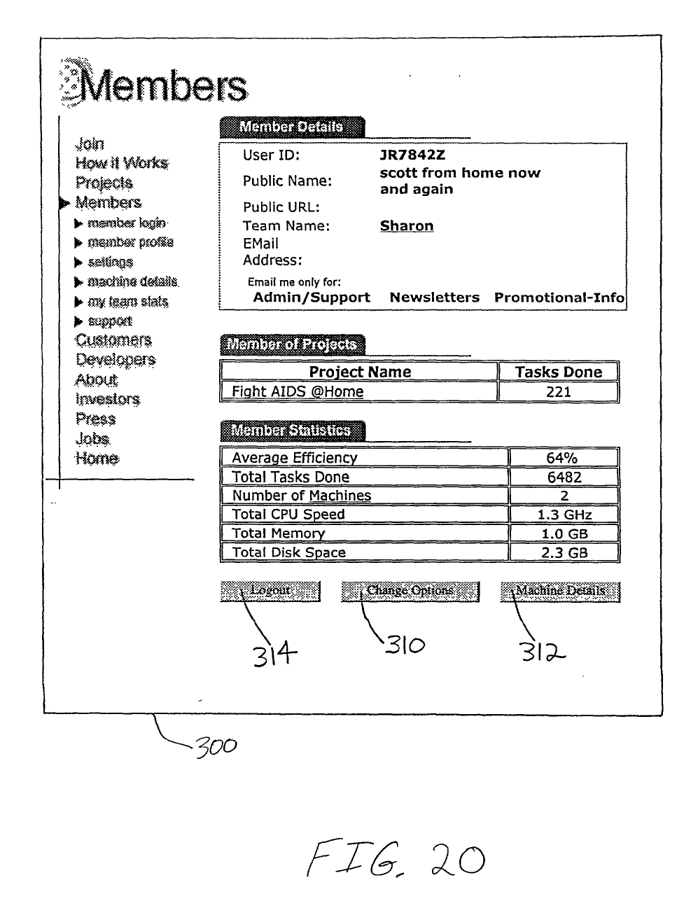

Referring to FIG. 19, there is illustrated an exemplary method for providing status information in accordance with one embodiment of the present invention. In step 250 each client 200 tracks or generates performance information for its executing module. By way of example, the performance information may be measured in terms of hours. The performance information may also include general machine performance statistics. In step 252 each client 200 sends the performance information to the Task Server 1200 upon completion of a module. The Task Server 1200 totals up and keeps track of the received performance information for the machines, accounts, teams, etc., in step 254. In step 256 the Task Server 1200 sends display data to each client 200. The display data is preferably HTML data and is configured to display status (performance) information for the machine, account, team, etc. In step 258 each client 200 adds performance information for its currently executing module to the values received from the Task Server 1200. Each client 200 displays the display data on its display screen in step 260. The display data may be displayed on the HTML page described above. The display data may also be displayed on the optional screen saver described above. It should be understood that several embodiments of the present invention do not require that all steps shown in FIG. 19 be performed or that the steps be performed in the listed order.

The Settings information provided on the background page may include hyperlinks that activate things. For example, a Desktop Preferences hyperlink may be used to activate the Tools and Program Settings menu properties view. This may include the options to hide the Tray Icon, not operate the client in laptop battery mode, and adjust the percentage of disk used by the client. A Network Connection hyperlink may be used to activate the Tools and Network Settings menu properties view. The option to choose a network connection type (1 of 5 during Configuration) is presented. Changes made here are queued to the Task Server 1200. A Member, Team and Projects (goes to system web site) hyperlink may be used to start the default web browser and takes the user to the system member's web site. A Send to a Friend (formats an email message to send hyperlink) hyperlink may be used to start the default email client and pre-format an email message with an invitation to join the member's team (if any).

The Help information provided on the background page may include, for example, a Desktop Reference that activates the default web browser to view a local disk file copy of a reference manual. The manual may describe how to use the client and has hyperlinks to the system web site, where appropriate. A System Support (goes to system web site) may activates the default web browser to view the system member's support page(s). A Version & software serial number may indicate the current client version and build. The software serial number is unique for each machine.

Additional application features may include that the HTML page changes with each application. A default page may be used for commercial or other applications without their own HTML page. A Dock-able/detachable toolbar for stop/start/pause (snooze)/help buttons may be included. The application is preferably capable of being minimized to a tray icon (which can be hidden).

In a preferred embodiment, additional operational features for the client 200 include that it can keep busy with cached work to “coast” between network connection windows. It may include the ability to get two tasks, one of which is done and the second to do between connections. It may include the ability to request an application task from the Task Server 1200, which may consist of one or more work units from an application server 1300. It may include the ability to service computing work for more than one Application Server 1300, the ability to suspend work in progress on one task to start another, and later resume the first, and the ability to spool outputs until network connection is reestablished. Finally, the client 200 can preferably be started/stopped/snoozed (paused) by the user.

It was mentioned above that a user can monitor the progress of his or her account, select which projects to participate in, and watch on the system web site the standing of any team he or she might create or join. Specifically, all machine, user, team, and task information, summaries of such information, or subsets of such information, may be made available through reports and interactive pages on an “integrated” web site. This “integrated” web site serves as a central account management site for all client computers. By way of example, such “integrated” web site may be accessed via the system web site for the distributed computing system 100. The “integrated” web site may be accessed by clicking on a “members” link on the system web site and then logging in by entering a member ID and password.

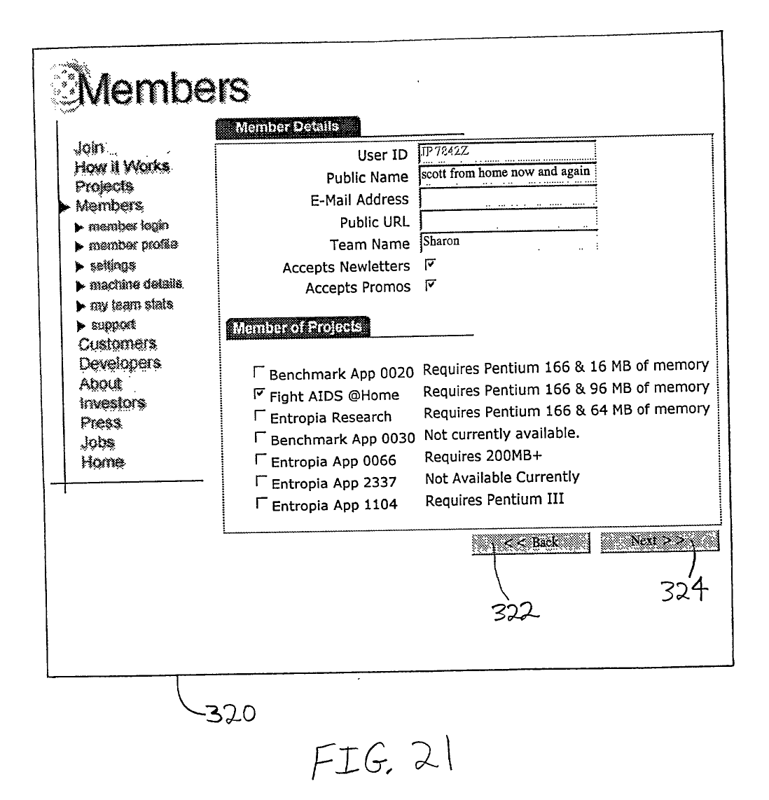

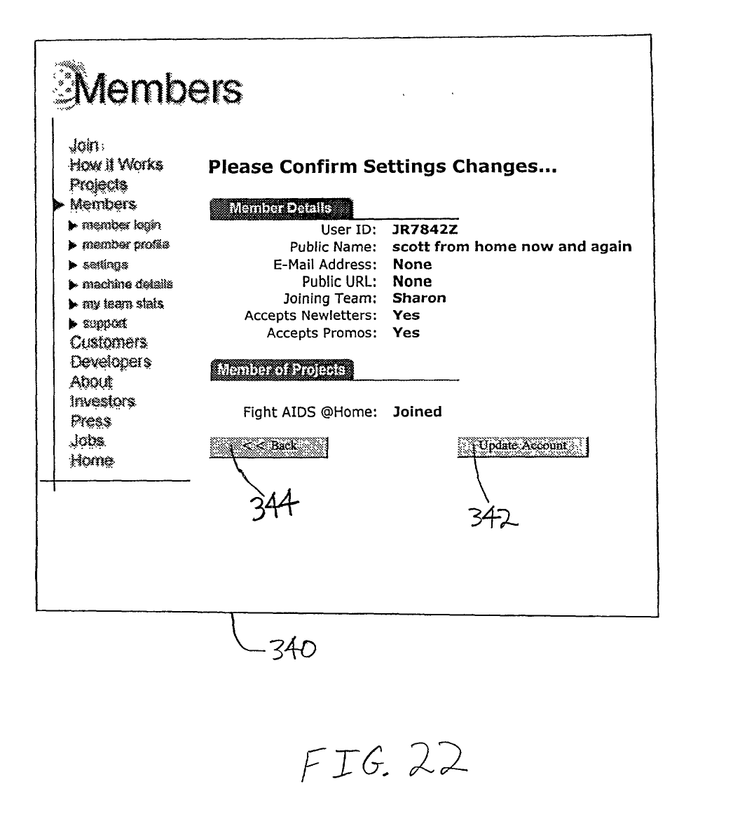

FIG. 20 illustrates an exemplary screen display 300 that can appear after logging in to the “integrated” web site. The display 300 includes a “Member Details” section, a “Member of Projects” section, and a “Member Statistics” section as illustrated. A user can make changes to settings by clicking on the change options button 310. FIG. 21 illustrates an exemplary change options display 320 that can be used for making changes. The user simply enters the changes in the “Members Details” section and/or the “Member of Projects” section of the display 320. The user can move to the previous screen or the next screen by clicking the back button 322 or the next button 324, respectively. By clicking the next button 324, a confirm settings changes display appears, such as for example the confirm settings changes display 340 shown in FIG. 22. The user can accept the changes and update the account by clicking the update account button 342. The user can move back to the previous screen and reenter information by clicking the back button 344.

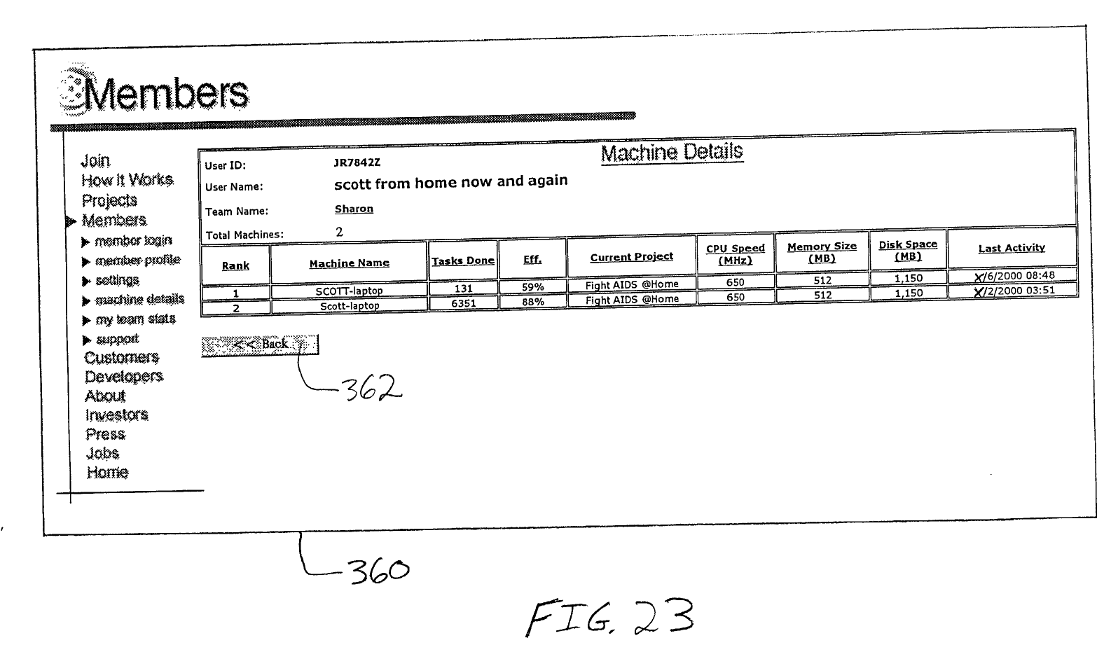

A user can view the machine details by clicking on the machine details button 312 on the display 300 (FIG. 20). FIG. 23 illustrates an exemplary machine details display 360 that may be used. The display 360 provides details for each of the user's machines, as illustrated. The user can return to the display 300 by clicking the back button 362. Finally, the user can logout of the “integrated” web site by clicking on the logout button 314.

The following description describes an architecture for an exemplary version of the client 200, i.e., the main system components, what they are, what they do and how they work together to achieve the goals outlined above. The subsystems of the client 200, their public interfaces, and any subsystem interactions and dependencies are described. While the invention herein disclosed is described by the specific embodiments and applications described, it should be well understood that numerous modifications and variations could be made thereto by those skilled in the art without departing from the scope of the invention.

The client 200 is one of the pieces in the larger picture of how the distributed computing system 100 described herein provides a highly distributed environment for large scale computing problems. One goal of all these different pieces is to enable the system to take on a very large computing problem, break it down into thousands of tasks and distribute it to tens of thousands of computers across the internet so this large computation could be performed by tens of thousands of parallel sub-computations and the results brought back from all these different clients 200.

One important advantage of the present invention is that it provides an environment where most of the software infrastructure stays intact when moving from one computation project to another. Preferably, the only thing that changes from one computation project to another is the code that actually performs the computation (which is referred to herein as an Application Module or a Computation Module) and the code that provides input data for this computation and saves the output results from it (which is referred to herein as an Application Server). The rest of the things preferably stay unchanged. An exemplary system organization diagram is illustrated in FIG. 3. Below, all the pieces of this infrastructure are described, and the client 200 is described in detail.

As described above, the Task Server 1200 contains information about which client 200 should perform which task. It also keeps track of the status of these tasks on all the clients 200. Clients communicate to this server for any task related information or status. Even other servers including Application Servers 1300 and File Servers 1100 communicate to the Task Server 1200 for user authentication and other similar things. The Task Server 1200 may be invoked through a web server (IIS 4.0 or later) and is preferably implemented as Active Server Pages or ISAPI filters along with ActiveX components.

Since each computation module is likely to be very different from another computation module, the Application Server 1300 keeps any module specific data, including providing any custom input to the module or receiving any output from the module. An application server handles its own kind computation module and resides on a web-server. However, the same web-server may house multiple different application servers depending on the work load. The application server may be invoked through a web server (IIS 4.0 or later) and is preferably implemented as Active Server Pages or ISAPI filters along with ActiveX components. So, two different application servers on the same web server would mean two different sets of ASP pages and ActiveX components.

The (upgrade) File Server 1100 contains any downloadable modules or software upgrades that the client 200 might require. The File Server may be invoked through a web server (IIS 4.0 or later) and is preferably implemented as ASP pages or ISAPI filters. The code running on the File Server, if any, is preferably very minimal and is preferably intended only for the purpose of user authentication. Other than this, the File Server's main purpose is preferably to house downloadable files.

Although FIG. 3 shows only one Task Server 1200, one File Server 1100, and one Application Server 1300, in reality each of these servers preferably exists in their respective web-farms. In a web farm, there is a load-balancer that redirects traffic to different participating web servers depending on the load factor of all the web servers in the web-farm. And, all of this is completely transparent to the client or the web-server.

A web farm can also handle situations where a session is created and kept alive for many different requests coming from a client and these requests need to be sent to the same web server to be processed. In this situation, all requests from a client 200 containing the same session ID are preferably sent to the same web server. If no session is created, then each request goes to the next available web server based on the load factor. This also means that when an Application Server 1300 or a File Server 1100 wants to contact a web server they also become another kind of a client and are treated the same way as all the clients are treated.

The Task Server 1200, an exemplary architecture of which is illustrated in FIG. 5, normally has the highest transaction load of all the servers and would need to ensure that it is designed for such scenarios. The Task Server has a small number of ASP pages and all the processing is preferably done in C++ based ActiveX components which call Stored Procedures in a Microsoft SQL Server 7.0 database. These ActiveX components are preferably under the control of Microsoft Transaction Server (MTS) so better connection and object pooling can be achieved under a high transaction environment.

One advantage of the client architecture described herein is that the entire client 200 can be broken down into various well defined subsystems. For each subsystem, the following discussion describes its responsibilities in the overall picture, its public interface or commitment to other subsystems, and its interaction with other subsystems both as a client subsystem and a server subsystem. A client subsystem is one that calls into another subsystems and the subsystem that receives and processes these calls is the server subsystem. A subsystem can be a client and server both for different other subsystems.

The client architecture described herein has many advantages, making it an ideal architecture. Specifically, the architecture avoids circular dependencies between subsystems. Circular dependencies can be avoided in most cases by introducing a third subsystem on which both original subsystem depend on. Circular dependencies complicates the design and makes the development and maintenance of these subsystems more difficult. The only exception to this is when asynchronous updates need to be made in the client based on something that happens in the server. In this case, ActiveX events for the server may be used to notify the clients.

Another advantage of the client architecture is that the public interface of the subsystems are kept small. The public interface of a subsystem consists of one or more public classes from that subsystem. The rest of the classes in that subsystem are kept private so they could be changed without impacting other subsystems.

Another advantage of the client architecture is that it is capable of using ActiveX for all use-interfaces. If the dependency on a subsystem is only for the purpose of using its public classes and not really inheriting from them, then it is advantageous to standardize the public interface to be implemented as ActiveX components. The private classes are not implemented as ActiveX components and instead are used by the public interface classes directly as C++ classes. However, all the public interface classes implement their respective ActiveX interfaces. The benefit of this is that the same subsystem can then be called from a variety of other environments including C++, Java, Visual Basic, and other scripting environment.

Another advantage of the client architecture is that it is capable of keeping things in one process unless specifically desired. Barring a specific reason for breaking things into multiple processes, everything should preferably be kept in one process. Within a process, multiple threads can be used for any parallel processing since Windows 95/98/NT does not distinguish between two separate processes versus two threads in the same process for the purpose of CPU scheduling. However, starting multiple processes consumes unnecessary resources and introduces overhead.

Another advantage of the client architecture is that each in-process subsystem may be a DLL. By making each in-process subsystem a DLL, the public/private concept can be enforced through the environment. In a DLL, everything is private unless specifically “exported” to the outside world. Additionally, a DLL provides a natural barrier for unnecessary dependencies on other subsystems and can be developed and tested in isolation.

The client architecture includes numerous other advantages.

FIG. 4 illustrates the architectural breakdown of an exemplary client 200 made in accordance with one embodiment of the present invention. The following describes all the different subsystems that make up the client 200. Each subsystem is first described briefly in order to give a quick and high-level understanding of how each subsystem fits into the overall picture. A more detailed description for each subsystem is provided below. It should be understood that the descriptions are for exemplary subsystems and that numerous modifications may be made to the subsystems without departing from the scope of the invention.

The term “Domain Objects” is used in some of the subsystems. This implies that this subsystem is focused primarily on managing application-specific information and provides an object oriented shape to this information. It also provides all the methods to manipulate this information including creation, saving, retrieving, changing, and deleting of any of this information. For some of the operations, the domain objects might depend on other subsystems that provide a persistence mechanism either to the local disk or to a server.

The Client EXE 270 includes a client GUI subsystem 272 and a client HTML page 274 (such as for example the HTML pages described above). The client GUI subsystem 272 is the top-most subsystem and has no public interface for others to call. Instead, it calls other subsystems. It provides all the GUI that the user sees. This subsystem has its own top-level User Interface thread that is able to receive all the user events and respond to them accordingly.

The client HTML page 274 contains an ActiveX control that is able to call other subsystems for the purpose of gathering some information and displaying it to the user as part of the HTML page. The client GUI provides the space for this HTML page.

The Task Manager subsystem 276 is called by the client GUI and the HTML page ActiveX control. It has a well defined subsystem through which most of the high level operations of the application can be controlled. Task Manager subsystem runs its own thread parallel to the client GUI.

The Task Domain Objects subsystem 278 manages all the information that is related to the task management aspect of the Task Manager. It provides an object model representing this information to the Task Manager so all the details of persistence are abstracted away from the Task Manager.

The Machine Info Domain Objects subsystem 280 manages all the machine related information including obtaining this information from the machine, saving it to local disk or the server, and presenting it to the client subsystem which at this time is Task Manager only.

The Performance Data Domain Objects subsystem 282 manages all the data that reflects the performance of the client and its Application Module(s) that is/are running. Again, it abstracts all the details of obtaining this information, saving it, and retrieving it from the local disk or the server. The end result is a much simplified view to its client subsystem which at this time is only Task Manager.

The Settings Domain Objects subsystem 284 manages all the user specified settings including their saving and retrieval from the local disk and the server. It is called both by the Task Manager and the client GUI. The GUI is the place from where the user is allowed to enter this information and the Task Manager uses this information to control its own behavior.

The Command and Recordset Objects subsystem 286 is responsible for all communication to the Task Server 1200 and the File Server 1100. It encapsulates all the details of preparing XML based commands to be sent to the server and retrieving XML based results from the server and parsing them back into a set of objects that the other subsystems can use. The clients of this subsystem are all the Domain object subsystems that have data to manage. They send all of their data to the Task server through this subsystem and also retrieve it from here, including the downloading of any Application Module files or a software upgrade.

The Network Detection Subsystem 288 specializes in finding out the network details of the client. It inquires about Dialup networking and the default Address book entry, and also finds out whether the network connection is live or not. This subsystem does not manage any information and instead returns the results of its findings to the client subsystem and let it manage this information.

The Persistent Queue Management subsystem 290 manages a Queue on the local disk that can be used by the Task Manager to queue requests for the Task Server. The only client subsystem for this is the Task Manager which may need to save information to the local disk if the network connection is not up. The Task Manager can later retrieve this information from this Queue and send it to the server when the connection is brought up.

The Application Module subsystem 292 is called by the Task Manager and is responsible for running the computation code that is specific to each computation project. Each computation project will have its own Application Module and there might be multiple Application Modules present on the local disk. Additionally, there might be multiple different Application Modules running on the client machine if it is an SMP (Symmetrical Multi Processor) machine. Each Application Module has an identical public interface that the Task Manager can call. Each Application Module runs in its separate process so it does not corrupt the main client process in case something goes wrong.

The UpgradeMe subsystem 294 is actually a separate EXE which is run by the client 200 whenever any software upgrades are required. The client 200 is responsible for finding out whether an upgrade is required or not and then also downloading the required file from the File Server 1100. Once all of that has been done, then UpgradeMe is invoked so it can safely upgrade the client which would have exited so it can be completed upgraded if needed.

The Common Subsystem is not a use-subsystem and therefore does not have an ActiveX based public interface. Instead, it contains reusable C++ classes which can use used inside most other subsystems or they can used as base classes for the purpose of enforcing standard behavior among different subsystems. Some of the things that are put in this subsystem are: Error Handling; Thread Management and Synchronization; and Commonly used utility classes.

The following discussion goes into more detail about each subsystem and describes its public interface, which makes it clear what are each subsystem's responsibilities and what is its public interface in terms of an object model.

Referring again to FIG. 16, the client GUI subsystem 272 includes all the GUI that the user sees except the contents of the HTML page 274. It provides the area where an HTML page can be shown. The GUI is preferably built with Microsoft Foundation Classes (MFC) as a Single Document Interface (SDI) application. For displaying an HTML page 274, an ActiveX control is preferably used.

The client GUI doesn't have a public interface that other subsystems can call as this is the top-most subsystem which calls other subsystems instead of having them call it. It does provide various commands to the user to help them control the behavior of the application. These commands are provided through the menu bar, the toolbar, and also from a popup menu from the taskbar when the application is minimized at the bottom-right of the screen. The following commands are preferably provided:

Disable: When this menu option is selected the application stops running except to receive further user events. The menu-option also displays a check-mark implying that this option is currently selected. If this option is selected from the toolbar, then the button becomes disabled until “Enable” command is selected. Additionally, the “Snooze” menu option and the toolbar button are disabled as well since they have no meaning in this state.

Enable: This menu item or toolbar button is initially disabled until “Disable” menu option is selected or toolbar button is pressed. At that time, this becomes enabled. When the user selects this menu item or the toolbar button, it becomes disabled and the “Disable” menu item and toolbar button become enabled.

Snooze: This menu item and toolbar button is initially enabled but when the user selects the “Disable” menu item or presses that toolbar button, this option becomes disabled. When the user selects the Snooze menu item or presses its button, it stays enabled and the application becomes “disabled”. Every time the user selects this menu option again or presses this toolbar button, the clocks starts again for the snooze-duration.

Exit: This exits the application and is only available from the FILE menu. There is no toolbar button for it so as to conform with the Windows standard.

Help: This invokes the local browser for the purpose of viewing a local HTML file containing some basic help. This file contains hyperlinks to more detailed information available at other servers.

Help About: This pops up a model dialog containing standard system and client information.

Each of the menus preferably includes the following sub-menus: File (Change password, Disable, Enable, Snooze, Exit); Tools (Network settings, User settings, Program settings); and Help (Contents, Help on the web, About the client).

The client HTML page 274 also preferably does not have any public interface and is invoked/loaded by the client GUI. It displays the contents of the HTML page which would contain an ActiveX control. One purpose of having this ActiveX control is to have the ability to obtain information about the state of affairs of the client dynamically and display it in the HTML page. Since the HTML page is intended for providing very easy to understand information to the user, it is a good place to also show the application's state and other information. The layout of this HTML page can preferably determined by anybody, including unrelated parties, and the client is preferably completely unaware of it.

The ActiveX control preferably displays the following information that it obtains from other subsystems. Specifically, it provides the user commands of Enable, Disable, and Snooze to the user. This would in turn be a call to other subsystems to actually perform the action. It displays user identity along with Machine ID and Team name if any. It displays the performance data about the client so far. This information can be obtained from the Performance Data Domain Objects subsystem. The ActiveX control can also obtain information directly from the Task Server 1200 as well by going through the Command and Recordset Objects subsystem.

The Task Manager subsystem 276 is one of the most involved subsystem of the client 200 as it is responsible for most of the behind-the-scene behavior of the client 200. However the public interface for Task Manager subsystem is very small and deals with situations where the GUI asks it to do something. The public interface includes the following operations:

Continue processing (Enable): The GUI asks the Task Manager to start or resume processing. The task manager needs to keep track of its state and determine whether to start from the beginning or resume an earlier suspension.

Suspend processing (Disable): The GUI asks the Task Manager to suspend processing immediately but do not exit.

Suspend processing for a time period (Snooze): The GUI asks the Task Manager to suspend processing for a specific period of time.

Exit immediately: Stop everything including an Application Modules and terminate yourself (meaning the Task Manager thread).

Exit after checkpoint: Stop processing when the next check-point is achieved and then let the GUI know through an ActiveX event that it has happened so the GUI can take appropriate actions.

Tell the GUI when a new tasks is started so the GUI can update HTML page: Fire an ActiveX event and let GUI know when a new task is started so the GUI can update the HTML page accordingly. Also, give the GUI the file-path of this new HTML page.

Some of the major responsibilities of the Task Manager include: running its own separate thread so the GUI thread is not used for this and the GUI can continue to receive events from the user; requesting a task from the Task Server to run; downloading an Application Module for a given task if necessary; running a task in an Application Module which is an ActiveX Server EXE and runs in its own parallel thread; controlling and communicating with the Application Module; sending status to the server and retrieving results from it (however, other subsystems are used for the actual work even though it is initiated by the Task Server); collecting performance data (another subsystem will do the actual collection of this data but the Task Manager would initiate it at appropriate times); error handling for any and all activities started by the Task Manager; keeping track of SMP environment and starting multiple Application Modules so there is one for each processor; keeping track of when the network connection is down and then initiating saving of data to the local disk for later sending to the Task Server; storing any commands for the Task Server in a persistent queue if the network connection is down (another subsystem actually does the Persistent Queue Management but all the calls to it are initiated by the Task Manager); asking the appropriate domain objects to save themselves locally or to the Task Server; determining when a software upgrade is necessary and then downloading the upgrade installation program from the File Server (then, informing the GUI client that we need to exit so the UpgradeMe.exe can take over); and when a connection is reestablished after some time of being disconnected, go through the persistent queue and send all the things to the Task Server that are pending there.

The Task Domain Objects subsystem 278 manages all the information that is related to the task management aspect of the Task Manager. It provides an object model representing this information to the Task Manager so all the details of persistence are abstracted away from the Task Manager. Most of the objects in this subsystem are public because they are intended to be used by other subsystems, namely the Task Manager at this time. Only the implementation details are provided in private objects.

Some of the public classes (public interface) in the Task Domain Objects subsystem are as follows. A Task class encapsulates all the task related information that is obtained from the Task Server 1200 or that needs to be sent to the Task Server 1200. An Application Module File class encapsulates the loading of the Application Module either from the File Server 1100 or from the local cache and running it as well. This does not represent the actual Application Module ActiveX Server that the Task Manager communicates with once it is running. This class is only responsible for making sure the Application Module DLLs are available and loaded. A Task Status call encapsulates any task related status information that the Task Manager needs to send to the Task Server 1200. It should be understood that there may be additional public classes for this subsystem.

The Machine Info Domain Objects subsystem 280 manages all the machine related information including obtaining this information from the machine, saving it to local disk or the server, and presenting it to the client subsystem. Some of the public classes of this subsystem include a Client Machine object which encapsulates all the machine information including CPU Model, CPU Speed, OS, Available RAM and more. It also contains the logic to go and determine this information from the machine, save it to the local cache or send it to the Task Server 1200.

The Performance Data Domain Objects subsystem 282 manages all the data that reflects the performance of the client 200 and its Application Module(s) that is/are running. Again, it abstracts all the details of obtaining this information, saving it, and retrieving it from the local disk or the server. The end result is a much simplified view to its client subsystem, the Task Manager. The public interface for the Performance Data Domain Objects subsystem includes a Performance Data class which is also responsible for gathering all the performance data from the machine. There is a separate instance of this class per App Module considering that there will be multiple App Modules running only in case of an SMP machine.

The Settings Domain Objects subsystem 284 manages all the user specified settings including their saving and retrieval from the local disk and the server. It is called both by the Task Manager and the client GUI. The GUI is the place from where the use is allowed to enter this information and the Task Manager uses this information to control its own behavior. The following classes constitute the public interface for this subsystem. The Network Settings object keeps all the user supplied network setting information and also saves and retrieves them from the local disk. The User Account class keeps track of all the user supplied account information. It is also responsible for talking to the server for the purpose of checking for uniqueness of a login name and if it is not unique then obtaining a Task Server suggested unique login name. The User Profile class keeps all the detailed user profile information which is optional for the user to specify. The Program Options class keeps all the user supplied program options and is also responsible for saving it to the local cache and retrieving it later.

The Network Detection Subsystem 288 specializes in finding out the network details of the client 200. It inquires about Dialup networking and the default Address book entry, and also finds out whether the network connection is live or not. This subsystem does not manage any information and instead returns the results of its findings to the client subsystem and let it manage this information. The Public Interface for this subsystem includes a Network Connection class which knows how to determine whether a network connection is established already or not and how to establish a network connection if needed.

The Persistent Queue Management subsystem 290 manages a Queue on the local disk that can be used by the Task Manager to queue requests for the Task Server 1200. The only client subsystem for this is the Task Manager which may need to save information to the local disk if the network connection is not up. The Task Manager can later retrieve this information from this Queue and send it to the server when the connection is brought up. The Public Interface for this subsystem includes the following. A Persistent Queue class represents the persistent queue management logic. It has the ability to insert an item at the tail of the queue, remove an item from the head of the queue, forcibly empty the queue, and determine how many items are currently present in the queue. A Persistent Queue Item class represents an individual item to be added to the persistent queue. It is able to keep the information passed to it by Task Manager which the Task Manager would later retrieve from the queue. This item is focused primarily on the Task Manager specific data but can be extended for other data as well in future.

The Command and Recordset Objects subsystem 286 is responsible for all communication to the Task Server 1200 and the File Server 1100. It encapsulates all the details of preparing XML based commands to be sent to the server and retrieving XML based results from the server and parsing them back into a set of objects that the other subsystems can use. The clients of this subsystem are all the Domain object subsystems that have data to manage. They send all of their data to the Task Server 1200 through this subsystem and also retrieve it from here, including the downloading of any App Module files or a software upgrade.

The Public Interface for the Command and Recordset Objects subsystem includes the following. A Command class is used to send a command/request to the Task Server 1200. It contains all the information that is required of a request or a command. A command can return a status stating the success or failure of this command. The command class prepares an XML string to be sent to the Task Server and receives the results back from the Task Server also in the form of an XML string. A Recordset class is used to retrieve the results of a command from the Task Server. Not every command is going to return a Recordset. Only those commands that return one or more rows of data will return a recordset. Recordset is returned by the Task Server in the form of an XML string which is then parsed with the help of Microsoft XML parser and the data put into the Recordset format. With a Binary Object class, if the result of a Command is an App Module or a software update exe, then it is returned as a Binary Object class. This is then saved to the local disk before taking any other action.

The Application Module (App Module) ActiveX Server subsystem 292 is called by the Task Manager and is responsible for running the computation code that is specific to each computation project. Each computation project will have its own App Module and there might be multiple App Modules present on the local disk. Additionally, there might be multiple different App Modules running on the client machine 200 if it is an SMP (Symmetrical Multi Processor) machine. Each App Module has an identical public interface that the Task Manager can call. Each App Module runs in its separate process so it does not corrupt the main client process in case something goes wrong.

The Public Interface for the Application Module ActiveX Server subsystem includes an Application Module class. This is an ActiveX interface which represents the actual App Module server running on the client machine. If there are more than one App Modules then either they each have different Interfaces or the same App Module runs multiple threads so each of them could be assigned to different CPUs. In either case, the interface to the Task Manager is the identical.

The Upgrade ME Program subsystem 294 is actually a separate EXE which is run by the client 200 whenever any client software upgrades are required. The client is responsible for finding out whether an upgrade is required or not and then also downloading the required file from the File Server. Once all of that has been done, then UpgradeMe is invoked so it can safely upgrade the client which would have exited so it can be completely upgraded if needed. Upgrading may be automatic, or can be prompted to the user before proceeding automatically. The availability of upgrades are preferably automatically checked when the client software starts, typically after the computer is booted up.

The Upgrade ME Program subsystem has no public interface as it is invoked through command line. It does the following when it is run: put the upgrade program in the WINDOWS startup folder in case the machine is rebooted; remove the client from the startup folder since it is no longer the valid version; run the setup.exe that came with the installation program that would upgrade client; when the setup.exe is successfully finished, remove the upgrade program from the WINDOWS startup folder and ensure that the client is back in the startup folder; and run the client and then exit itself.

Regarding Common Used Classes, this is not a use-subsystem and therefore does not have an ActiveX based public interface. Instead, it preferably contains reusable C++ classes which can be used inside most other subsystems or they can be used as base classes for the purpose of enforcing standard behavior among different subsystems. Some of the things that are put in this subsystem are Error Handling and Thread Management and Synchronization. Error handling catches all final exceptions “errors” and logs those to disk files.

One purpose of the Error Handling class is to encapsulate all the error handling and error manipulation code. It provides the ability to load error messages from a string table thereby allowing the errors to be in any international language. It also allows the ability to add run time arguments to the errors and substitute them into the error string based on a location specified in the error message. This also enables the run time argument location to changed when the language changes from English to another language as the sentence structure and grammar of different languages would force the same run-time argument to appear at different locations in the message. It also constructs a COM ERROR and throws it so the client of a subsystem which is calling this subsystem through ActiveX can trap all the error through regular ActiveX mechanism.

The Thread Management and Synchronization is a base abstract class that normally must be derived before it can be used. The derived class must implement “RunInstance( )” method which is called to do the actual “work” of the thread. When this method returns, the Thread is automatically deleted. Therefore, as long as this thread has to live, this method should not return. If there are thread-specific things that need to be initialized once before it starts running, then the derived class must normally override the “InitInstance( )” method. This class also provides the ability to do thread synchronization with the help of WIN32 support of Critical Sections. It also allows other threads to send events to this thread which helps thread coordinate their work better.

The following describes exemplary Application Module integration features for the client 200. In other words, the following describes what an application module preferably supports when operating within the client execution framework. To fully “hook up” an application module, each of (a) below is preferably supported. At the minimum, an application module preferably supports each of (b) below. It should be well understood, however, that these are only example features and that numerous modifications may be made in accordance with the present invention. Again, Application Modules are also referred to herein as Computation Modules.

With respect to installation of the application module, the (a) fully integrated preferred features include: creates own settings & operational file data; default settings hard-coded; uses files for settings & state (not registry keys or DB); initial settings pre-configured in settings files; and uninstall requires only deleting files. The (b) minimum non-integrated preferred features include: creates own settings & operational file data; initial settings pre-configured in settings files; and uninstall requires only deleting files.

With respect to ActiveX control responsiveness of the application module, the (a) fully integrated preferred features include: listens & responds to the client ActiveX messages for checkpoint state to disk (can be a no-op if irrelevant), stop, with intent to resume from checkpoint, stop, cleanup and abandon work, exit immediately; and responds to the client messages within 1 second. The (b) minimum non-integrated preferred features include: manages its own checkpoint state; can be started by launching; can be resumed from checkpoint by launching; can be stopped w/checkpoint by Windows exit message; and can be (safely) killed if necessary.

With respect to the application module having no GUI, the (a) fully integrated preferred features include: no GUI code at all. The (b) minimum non-integrated preferred features include: GUI can be completely hidden from view of user; and GUI can be made to NOT respond to direct control by user (typically keyboard & mouse).

With respect to the system resource use of the application module, the (a) fully integrated preferred features include: uses client file I/O APIs (which control location, names, encryption, sizes, etc.); uses client memory APIs (which control amount of memory allocated); uses client CPU APIs (which control access to CPUs, priority, affinity); uses Windows default application priority type 3, to allow other applications & services and to pre-empt as needed. The (b) minimum non-integrated preferred features include: uses file data in the installed path only; uses Windows default application priority type 3, to allow other applications & services and to pre-empt as needed; uses fixed/reasonable max upper limit memory; and sets own CPU affinity.

With respect to the network I/O for the application module, the (a) fully integrated preferred features include: requests info from the client such as network connection type & speed; uses the system network I/O APIs (which control addressing, encryption, identity, authentication, bandwidth, sizes, etc.); and communicates with designated application server. The (b) minimum non-integrated preferred features include: uses HTTP (port 80) for all traffic; all connections are client-originated; uses settings-configurable network server addresses; uses fixed/reasonable max network limits such as download data sizes limited by connection speed, must get data in under a few minutes max, and can perform transactions with E-I network within a few seconds of time; gets userID/userPW & machine GUID from conFIG. files; userID/userPW and machine GUID sent to application server(s) for all transactions (get work, update work, work done, etc.); and communicates with designated application server.

In this architecture, the client 200 communicates with a system network control server (typically the Task Server 1200 described above, which is physically a group of servers). The application module communicates with the application server 1300, which specializes in handling a specific computing application by assigning work units to the corresponding application modules on various distributed computers. The application servers 1300 also communicate with the Task Server 1200, to authenticate client userID/userPW and machine GUIDs, tell it how many of what kind of machine is needed, and when they gave which machine what to do.

On each computer, the client 200 is a task management agent for the Task Server 1200. The client 200 controls the execution of application modules preferably using an ActiveX service process, which is a container for either an application Module EXE program. The ActiveX service controls the application module, and the client controls the ActiveX service.

The following discussion describes one exemplary version of a Task Server 1200 Engine design made in accordance with one embodiment of the present invention. This Engine is used to process all the requests coming from different clients including user clients 200, Application Servers 1300, and File Servers 1100. While the invention herein disclosed is described by the specific embodiments and applications described, it should be well understood that numerous modifications and variations could be made thereto by those skilled in the art without departing from the scope of the invention.

The Task Server 1200 Engine described herein is capable of handling a large number of transactions per minute. This is in part due to having a web-farm and doing load-balancing to multiple Task Servers. This provides for a very high transaction rate for a given Transaction Server.

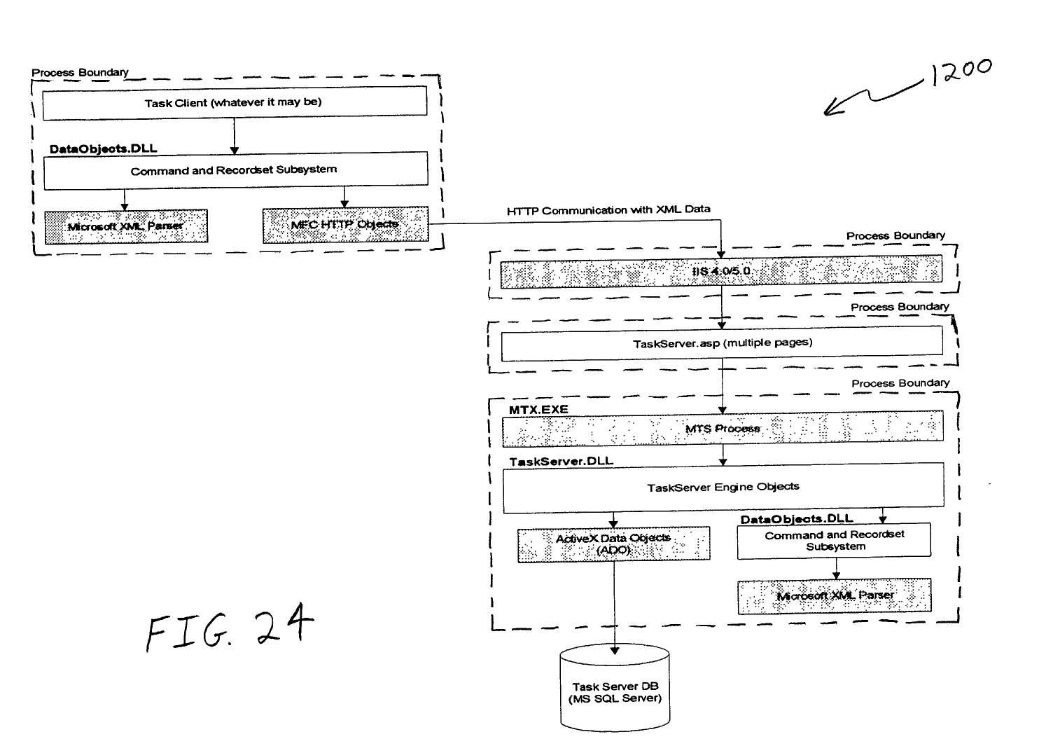

Referring to FIG. 24, there is illustrated an exemplary system organization for the Task Server 1200 Engine. The organization of this system is preferably such that it allows any client that wants to communicate with the Task Server 1200 to reuse Command and Recordset objects that deal with all the complexity of the communication protocol.

In a typical exemplary situation, a command would preferably be executed in the following way:

1. The client specifies all the command information to the Command object and asks it to execute.

2. The command object creates an XML string containing all the command information.

3. The command object sends this XML string to the Task Server 1200 by using MFC Http classes. This is an HTTP GET or a POST call and is actually invoking an Active Server Pages (ASP) page on the Task Server

4. The Task Server 1200 invokes the appropriate ASP page and passes this information to it.

5. The ASP page immediately instantiates the ActiveX component and passes all the XML data to it and waits for it to return an XML-formatted answer.

6. The ActiveX component uses the Command object which then uses the Microsoft XML parser to parse the information. The ActiveX component is then able to read this information from the Command object.

7. The ActiveX component builds a Stored Procedure execute SQL statement from this information from the Command object.

8. The ActiveX component executes the SQL statement resulting in the stored procedure being executed.

9. The results of the stored procedure are either a status of success or failure or a cursor that needs to be opened by the ActiveX component.

10. The ActiveX component opens the cursor and reads the results one row at a time.

11. The ActiveX component uses the Recordset object of the Command and Recordset subsystem to construct an XML string for all the rows returned by the stored procedure.

12. The ActiveX component sends this XML string back to the ASP page which then sends it back to the client's Command object.

13. The Command Object on the client side then determines whether only status needs to be returned to its caller or whether a Recordset needs to be created containing all the rows that were returned by the Task Server 1200. It does whatever is necessary and returns this information to the caller.

14. The caller can obtain all the rows of data from the Recordset object by going into a loop.

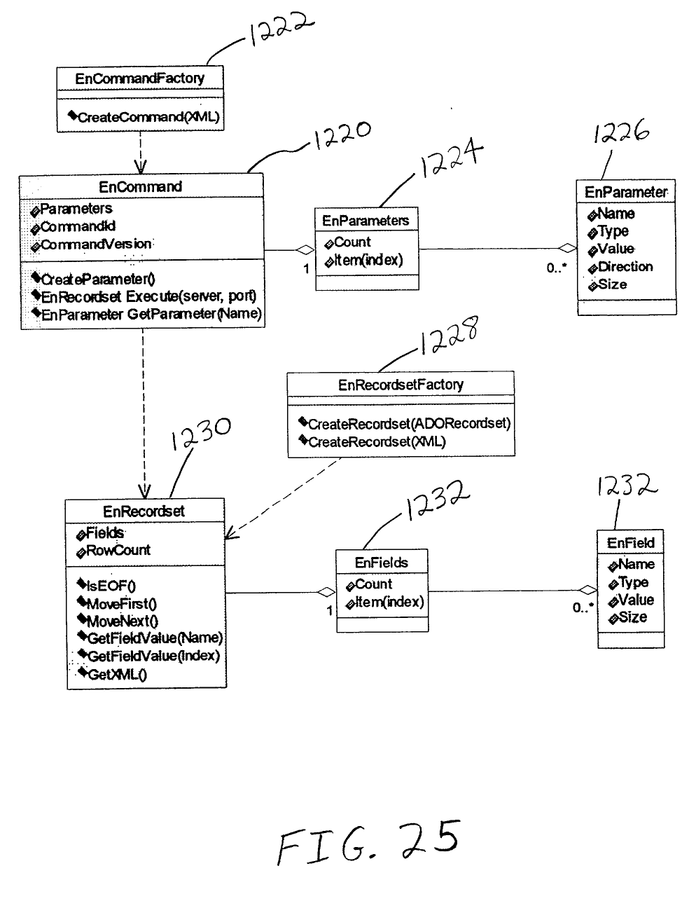

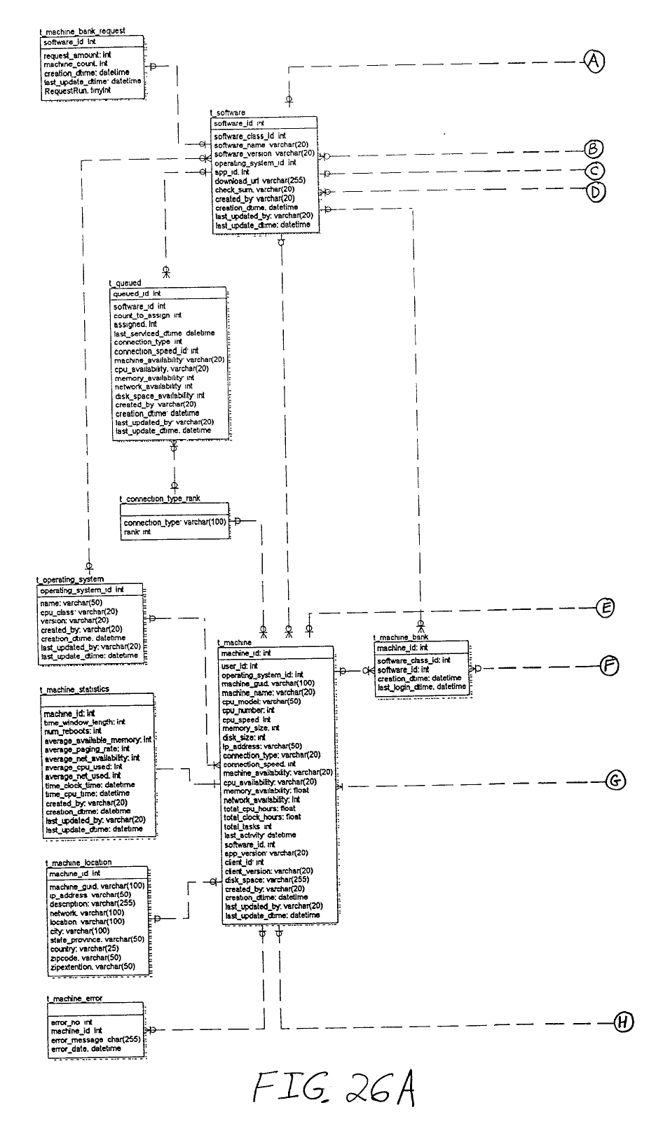

Referring to FIG. 25, there is illustrated an exemplary class diagram for command and recordset subsystem. With respect to command and recordset Design, the Task Server 1200 preferably uses two classes for the purpose of sending commands from the client to the server and receiving their results from the server to the client. These classes are used by client and the server so all the logic of encoding and decoding XML messages is embedded here.

The EnCommand class 1220 is used by the client first to issue commands and their arguments to the server. Once a command is executed, it returns a status and optionally a Recordset object if the command was supposed to return one or more rows of data. With respect to the EnCommand Attributes, every command preferably contains the following information with it:

Command ID: This is a 32-bit numeric value that represents a command on the server side. This command mostly translates into a stored procedure call but may even translate into other non-database calls.

Command Version: This is to allow us to provide backward compatibility of a certain command.

Zero or more arguments: A command contains zero or more argument objects in a sequence.

With respect to EnCommand Methods, every EnCommand object is preferably constructed for one of two reasons. It is either to construct a command and execute it over an HTTP connection, or, it is constructed by the server for the purpose of traversing what a client has sent to the server. EnCommand Methods may include:

CreateParameter(Name, Type, Direction, Size, Value): This method is called whenever a new parameter needs to be created for a particular command. This method is usually called by the client before it wants to call Executeo method.

EnRecordset Execute(Server, Port, Flag Deferable): This method is called to actually execute the command. The command is executed by first preparing an XML string which is then sent to the server through HTTP protocol GET command. Then, the result of that command is returned either as only a status or a status and a set of rows (as an XML string). If the status is a failure, an ActiveX exception is thrown which the caller must catch. If the status is a success then a EnRecordset object may optionally be returned if there are one or more rows of data returned from the server. Flag Deferable allows the option to “spool” and transmit later, when a network connection is available.

The EnCommandFactory class 1222 is used by the server to reconstruct an EnCommand object from the XML string that was sent by the client. It only has one method called CreateCommand(XML) which takes an XML string as an argument and returns an EnCommand object.

The EnParameter class 1224 represents one parameter of an EnCommand object. A parameter is any argument to be passed to the command and this argument can be either input, output, or input/output. The EnParameter Attributes 1226 may include the following:

Name: This is a string attribute which represents the name of the argument. This is an optional argument.

Type: This can take one of the following values: eText (For this value, the caller must also specify a size.); einteger; eLong; eDouble; ecurrency; eDateTime.

Direction: This takes one of the following values: einput; eOutput; eInputOutput; eReturnValue.

Size: This takes a number to indicate the size of an “eText” type.

Value: This is a VARIANT and can take any of the above data type values or return those values.

The EnRecordsetFactory class 1228 is used by either the Client or the Server to construct an EnRecordset object based either on an ADO Recordset object or an XML string. In either case, it constructs an appropriate EnRecordset object and returns it.

The EnRecordset class 1230 is used to represent one or more rows of data returned by the execution of a command. The Client uses this object to traverse over the results of a command. The server uses this class to construct the result of a command from an ADO Recordset object and then uses this object to construct an XML string which is then returned to the client. The EnRecordset Attributes may include:

Fields: This returns a collection of EnField objects. Each EnField object represents a column with its value for the current row.

RowCount: This tells us how many rows are in the recordset. The only thing that is guaranteed is that it will not be zero if there is at least one row in the recordset.

Other than that, this may not contain the most accurate count of rows in the recordset.

The EnRecordset Methods may include:

IsEOF: While iteration over a recordset, this method tells us whether we have reached the end or not.

MoveFirst: Move to the first row in the recordset

MoveNext: Move to the next row in the recordset. This method should be called after doing a check for IsEOF. If we are already at the last row of a recordset and this method is called, it returns without an error but the if we do not call IsEOF and directly try to get the contents of the next row (perhaps by calling GetFieldO), we will get an error. So, we must always call IsEOF before and after calling MoveNext.

GetFieldValue(Name), GetFieldValue(Index): There are two ways to obtain the value of a field, one is by name and the other is by index. In both cases, a VARIANT is returned containing the value. The caller can either inquire the data type from the EnField object or from the VARIANT structure or they can know up-front about it.

The EnField class 1232 stores the value of a column for a row. It also contains other information like column name, data type, and data size. This is a read only object for the caller.

An XML string is sent by EnCommand to the Server. Specifically, when an Execute method is called on the EnCommand object, it preferably prepares the following XML string and sends it to the Server. The Server then uses the EnCommandFactor class and gives it this XML string so it can recreate the EnCommand object on the server side.

<EnCommand>

<CommandID> 1234567890 </CommandID>
<CommandVersion> 1.0 </CommandVersion>
<EnParameters>

<EnParameter>

<Name> arg1 </Name>
<Type> eText </Type>
<Direction> eInput </Direction>
<Size> 60 </Size>
<Value> The quick brown fox jumps over the lazy

dog. </Value>

</EnParameter>
<EnParameter>

<Name> arg2 </Name>
<Type> eInteger </Type>
<Direction> eInput </Direction>
<Value> 4000 </Value>

</En Parameter>
<EnParameter>

<Name> arg3 </Name>
<Type> eCurrency </Type>
<Direction> eInput </Direction>
<Value> 1000.55 </Value>

</EnParameter>
<EnParameter>

<Name> arg4 </Name>
<Type> eDateTime </Type>
<Direction> eInput </Direction>
<Value> Jan 01, 2000 05:30:00.000 am

</Value>

</EnParameter>

</EnParameters>

</EnCommand>

An XML string is returned by server. Specifically, when the server receives a command from the client, it executes that command either in the form of a stored procedure or an ActiveX object method and then returns the result back to the client. The results are sent back as an XML string again and the client then parses this XML string to first get values for any OUTPUT or RETURNVALUE EnCommand parameters and then to construct an EnRecordset object (if there is data for it).

<EnResults>

<EnCommand>

<CommandID> 1234567890 </CommandID>
<CommandVersion> 1.0 </CommandVersion>
<EnParameters>

<EnParameter>

<Name> arg3 </Name>
<Type> eCurrency </Type>
<Direction> eInputOutput </Direction>
<Value> 3500.55 </Value>

</EnParameter>
<EnParameter>

<Name> arg4 </Name>
<Type> eDateTime </Type>
<Direction> eOutput </Direction>
<Value> Jan 01, 2000 05:30:00.000 am

</Value

</EnParameter>

</EnParameters>

</EnCommand>
<EnRecordset>

<RowCount> 3 </RowCount>
<Row>

<EnField>

<Name> column1 </Name>
<Type> eInteger </Type>
<Value> 3500 </Value>

</EnField>
<EnField>

<Name> column2 </Name>
<Type> eCurrency </Type>
<Value> 3500.55 </Value>

</EnField>
<EnField>

<Name> column3 </Name>
<Type> eText </Type>
<Value> The quick brown fox jumps high.

</Value>

<Size> 60 </Size>

</EnField>

</Row>
<Row>

<EnField>

<Name> column1 </Name>
<Type> eInteger </Type>
<Value> 4000 </Value>

</EnField>
<EnField>

<Name> column2 </Name>
<Type> eCurrency </Type>
<Value> 4500.55 </Value>

</EnField>
<EnField>

<Name> column3 </Name>
<Type> eText </Type>
<Value> Iqbal Khan </Value>
<Size> 60 </Size>

</EnField>

</Row>
<Row>

<EnField>

<Name> column1 </Name>
<Type> eInteger </Type>
<Value> 5000 </Value>

</EnField>
<EnField>

<Name> column2 </Name>
<Type> eCurrency </Type>
<Value> 5500.55 </Value>

</EnField>
<EnField>

<Name> column3 </Name>
<Type> eText </Type>
<Value> Scott Kurowski </Value>
<Size> 60 </Size>

</EnField>

</Row>

</EnRecordset>

</EnResults>

One job of a Task Server 1200 Engine is to accept commands from various clients, translate them into appropriate stored procedure calls or other API calls, execute the stored procedure or the API, and return the result back to the client. Regarding the control flow of the Task Server 1200 Engine, below are the high level steps that the Task Server 1200 preferably takes when it receives a command from a client:

1. It receives the command as an XML string from an ASP page.

2. It invokes EnCommandFactory object to reconstruct the EnCommand object from the XML string.

3. It traverse over the information in the EnCommand object and based on its CommandID, it goes to the database and determines which stored procedure needs to be called. It also determines whether the stored procedure is supposed to return a cursor or not.

4. It prepares an ADO Command object and passes all the parameters from EnCommand to it. It also specifies the stored procedure's name to be called.

5. It executes a stored procedure and if the stored procedure is supposed to return a cursor then it creates an ADO Recordset object.

6. It invokes EnRecordsetFactory object and passes it the ADO Recordset object so an equivalent EnRecordset object could be created. It gets the EnRecordset object from EnRecordsetFactory object.

7. It converts the result of both ADO Command object and ADO Recordset objects back into an XML string and returns it back to the ASP page.

8. ASP page sends this XML string back to the client as the result of the command execution.

With respect to an ASP Page, all Task Server requests are preferably issued to only one ASP page called TaskServer.asp. This page takes in an XML string through an HTTP GET and returns the results back to the client again as an XML string.

With respect to finding a stored procedure, the Task Server 1200 does not know what each command means and relies on the data in the database to even determine which stored procedure to call and whether this stored procedure would return data or not. From the database, it only retrieves the stored procedure name and whether it returns any data or not. It is assumed that the client already knows about all the arguments to the stored procedure and a command really represents a stored procedure call in this situation. Therefore, if the number of arguments are incorrect, a SQL error is returned back to the client.

The Command Table preferably has the following columns:

Command ID: This is the same id that the EnCommand passes to the server. They (preferably) have to match completely.

Command Version: This is the same version that EnCommand passes to the server. They (preferably) have to match completely.

StoredProcedure: This is name of a stored procedure that should be called to cater this command.

ReturnsData: This is a flag which determines whether this stored procedure is supposed to return data or not (meaning zero or more rows).

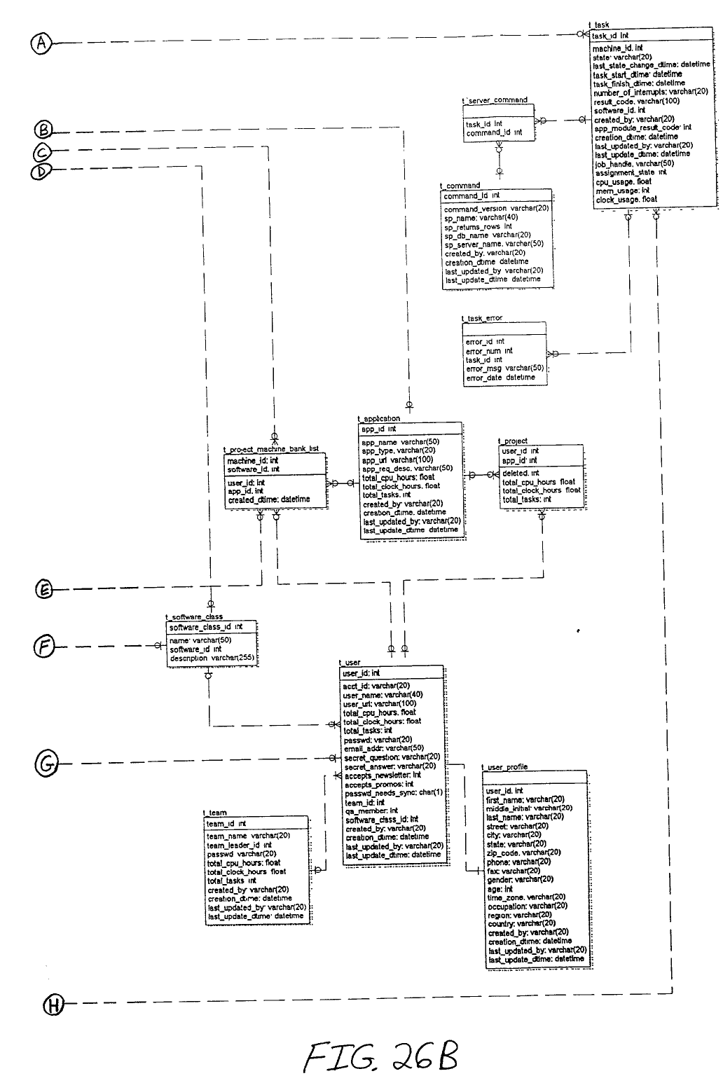

With respect to the Task Server Database Design, FIGS. 26A and 26B form an ER diagram illustrating an exemplary Task Server Core Database logical and physical design. FIG. 26A connects to FIG. 26B at nodes A, B, C, D, E, F, G and H. The following are descriptions of several of the illustrated entities:

t_team: This entity represents teams of users who are perhaps participating in a project together. Having a team is an optional feature and users do not have to become part of a team. However, if they do become part of a team, then they can track the performance of the overall team.

t_user: A user is anyone (person) who signs up to participate in the distributed computing system. A user is not bound to one machine only but can have multiple machines being used either simultaneously or at different periods of time.

t_command: All the commands that the Client (or other clients) can issue to the Task Server are represented by command_id and command_version. This table tells the Task Server which stored procedure to run in order to fulfill this command. This also keeps information about remote stored procedures (if needed).

t_user_profile: A user may optionally provide his/her profile. If they do so then it is stored in this entity.

t_machine: A machine is a computer that is being used to run the application modules. Every machine is preferably uniquely identified in the system by a GUID. The database keeps its own unique id called “machine_id”. A machine can have more than one CPU in which case the user can specify how many of these CPUs they want to contribute toward distributed computing projects. Each CPU can run its own application module and have a true parallel computing on a machine.

t_machine_statistics: Statistics are kept for every machine over time so the performance of each machine can be monitored.

t_operating_system: Every machine has an operating system running on it. This, for example, can be Windows NT, Windows 98, Windows 95, Windows 2000, and more.

t_task: A task is the running of a single application module on a machine. An application module is defined by the software_id and the machine is identified by the machine_id. A machine can have multiple tasks running on it simultaneously if it has multiple CPUs. Additionally, a machine can have multiple tasks that were suspended before they could finish because another more important task had to be started. These interrupted tasks may be started in future when the machine is free.

t_software: Software is anything that is downloaded onto the client machine and run. This can be the actual Client software or it can be an application module. They are all preferably treated the same way for the purpose of tracking their versions and download urls.

U.S. Provisional Patent Application No. 60/215,746, filed Jul. 6, 2000, entitled METHOD AND SYSTEM FOR NETWORK-DISTRIBUTED COMPUTING, by inventors Scott J. Kurowski and Iqbal Mustafa Khan, is hereby fully incorporated into the present application by reference.

While the invention herein disclosed has been described by means of specific embodiments and applications thereof, numerous modifications and variations could be made thereto by those skilled in the art without departing from the scope of the invention set forth in the claims.

What is claimed is:

1. A system for use in distributed computing, comprising:
a task server configured to keep track of information associated with each of a multiplicity of client computers and to use the information to assign one or more tasks associated with a computing problem to each client computer;
a file server configured to provide application modules to the client computers for executing their assigned tasks; and
an application server configured to provide input data for the application modules to the client computers and to receive output data of the application modules from the client computers.

2. A system in accordance with claim 1, wherein the application modules are configured to be executable by a universal client program.

3. A system in accordance with claim 2, wherein the file server is further configured to provide the universal client program to the client computers

4. A system in accordance with claim 1, wherein the information comprises user identification information.

5. A system in accordance with claim 1, wherein the information comprises a unique machine identification number for each client computer.

6. A system in accordance with claim 1, wherein the information comprises status information for tasks being executed on client computers.

7. A method for use in a distributed computing system, comprising the steps of:
providing a client program for installation on a client computer;
receiving, through a computer network, information associated with the client computer that is collected by the client program installed on the client computer;
using the information to assign one or more tasks associated with a computing problem to the client computer; and
providing one or more application modules to the client computer for executing its assigned tasks, wherein the application modules are executable by the client program and are provided through the computer network.

8. A method in accordance with claim 7, wherein the steps of receiving and using are performed by a first server, and the step of providing is performed by a second server.

9. A method in accordance with claim 7, wherein the information comprises machine identification information.

10. A method in accordance with claim 7, wherein the information comprises processor information.

11. A method in accordance with claim 7, wherein the information comprises memory information.

12. A method in accordance with claim 7, further comprising the step of:
receiving team identification information from the client computer through the computer network;

13. A method in accordance with claim 7, further comprising the step of:
receiving performance information from the client computer through the computer network;

14. A method in accordance with claim 13, further comprising the step of:
adding the performance information to additional performance information for a team of client computers with which the client computer is associated.

15. A method for use in a distributed computing system, comprising the steps of:
sending a request for a new task through a computer network to a first server, the request including user identification information;
receiving module information from the first server through the computer network in response to the request, the module information including locator information for a second server in the computer network where a module can be obtained;
redirecting to the second server using the locator information; and
receiving the module from the second server through the computer network.

16. A method in accordance with claim 15, wherein the module information is based at least in part on the user identification information.

17. A method in accordance with claim 15, wherein the request further comprises machine identification information.

18. A method in accordance with claim 15, wherein the module information further comprises module identification information.

19. A method in accordance with claim 15, wherein the module information further comprises module version information.

20. A method in accordance with claim 19, further comprising the step of:
deleting an older version of the module.

21. A method in accordance with claim 15, wherein the computer network comprises the Internet.

22. A method in accordance with claim 15, further comprising the step of:
starting the module.

23. A method in accordance with claim 15, further comprising the step of:
receiving a command from the first server through the computer network that suspends execution of the module.

24. A method in accordance with claim 15, further comprising the step of:
receiving a command from the first server through the computer network that terminates execution of the module.

25. A method in accordance with claim 15, further comprising the step of:
sending status information through the computer network to the first server.

26. A method in accordance with claim 25, wherein the status information comprises a current state for the module.

27. A method for use in a distributed computing system, comprising the steps of:
receiving a request for a new task from a client through a computer network, the request including user identification information;
assembling module information in response to the request, the module information including locator information indicating a location in the computer network where a module can be obtained;
sending the module information to the client through the computer network; and
sending the module to the client through the computer network from the location in the computer network.

28. A method in accordance with claim 27, wherein the request further comprises machine identification information.

29. A method in accordance with claim 27, wherein the module information further comprises module identification information.

30. A method in accordance with claim 27, wherein the module information further comprises module version information.

31. A method in accordance with claim 27, wherein the step of assembling module information is performed by a task server and the step of sending the module to the client is performed by a separate file server.

32. A method in accordance with claim 27, wherein the computer network comprises the Internet.

33. A method in accordance with claim 27, further comprising the step of:
sending a command to the client through the computer network that suspends execution of the module.

34. A method in accordance with claim 27, further comprising the step of:
sending a command to the client through the computer network that terminates execution of the module.

35. A method in accordance with claim 27, further comprising the step of:
receiving status information from the client through the computer network.

36. A method in accordance with claim 35, wherein the status information comprises a current state for the module.

37. A method of providing status information associated with a distributed computing project, comprising the steps of:
generating a first item of performance information for a first client computer participating in the distributed computing project;
sending the first item of performance information from the first client computer through a computer network to a first server;
receiving a second item of performance information at the first client computer from the first server through the computer network, wherein the second item of performance information is based on the first item of performance information and one or more additional items of performance information from one or more additional client computers participating in the distributed computing project; and
displaying the second item of performance information on the first client computer.

38. A method in accordance with claim 37, wherein the first item of performance information comprises an amount of time that a processor in the first client computer spent on a task for the distributed computing project.

39. A method in accordance with claim 37, wherein the second item of performance information comprises a total amount of time that a team of client computers spent on the distributed computing project.

40. A method in accordance with claim 37, wherein the step of displaying comprises the step of:
displaying a hypertext markup language (HTML) page having the second item of performance information thereon.

41. A method in accordance with claim 37, further comprising the step of:
displaying a name of a team on the first client computer, wherein the team includes the first client computer and the one or more additional client computers.

42. A method in accordance with claim 37, further comprising the step of:
displaying the first item of performance information on the first client computer.

43. A method in accordance with claim 42, further comprising the step of:
displaying a name associated with the first client computer on the first client computer.

44. A method of providing status information associated with a distributed computing project, comprising the steps of:
receiving, through a computer network, performance information from a plurality of client computers participating in the distributed computing project;
totaling the performance information for a subset of the plurality of client computers that are members of a first team in order to generate team performance information; and
sending display data through the computer network to each of the client computers that are members of the first team, wherein the display data is configured to display status information that includes the team performance information.

45. A method in accordance with claim 44, wherein the team performance information comprises a total amount of time that the first team of client computers spent on the distributed computing project.

46. A method in accordance with claim 44, wherein the display data comprises a hypertext markup language (HTML) page.

47. A method in accordance with claim 44, wherein the display data is further configured to display a name of the first team.

48. A method in accordance with claim 44, wherein the display data is further configured to display performance information for a client computer to which the display data is sent.

49. A method for use in a distributed computing system, comprising the steps of:
offering an incentive for a commitment of computing time from a user's computer in the distributed computing system;
providing a client program to the user for installation on the user's computer;
registering the user's computer as a client in the distributed computing system; and
providing the incentive to the user.

50. A method in accordance with claim 49, wherein the step of providing a client program to the user comprises the step of:
sending the client program through a computer network to the user's computer.

51. A method in accordance with claim 49, wherein the step of registering the user's computer as a client comprises the step of:
receiving, through a computer network, information associated with the user's computer that is collected by the client program installed on the user's computer.

52. A method in accordance with claim 49, wherein the incentive comprises shares in a company.

53. A method in accordance with claim 49, wherein the incentive comprises money.

54. A method in accordance with claim 49, wherein the incentive comprises frequent-flyer miles.

55. A method in accordance with claim 49, wherein the step of providing the incentive to the user comprises the step of:
providing the incentive to the user upon completion of a committed amount of computing time in the distributed computing system.
